(19) United States
(12) Patent Application Publication
(10) Pub. No.: US 2011/0256350 A1
(43) Pub. Date: Oct. 20, 2011

(54) FUNCTIONAL LAMINATE AND FUNCTIONAL STRUCTURE

(75) Inventor: Hiroyuki Ito, Miyagi (JP)

(73) Assignee: SONY CORPORATION, Tokyo (JP)

(21) Appl. No.: 13/071,111

(22) Filed: Mar. 24, 2011

(30) Foreign Application Priority Data
Mar. 31, 2010 (JP) P2010-081465

(51) Int. Cl. B32B 3/00

(52) U.S. Cl. 428/156

(57) ABSTRACT

A functional laminate includes a functional layer including an inorganic layer formed in a predetermined three-dimensional shape, first and second resin layers disposed in close contact with two principal surfaces of the functional layer, respectively, and sandwiching the functional layer therebetween, and first and second supports disposed respectively in contact with one surface of the first resin layer on a side oppositely away from the other surface thereof, which is contacted with the functional layer, and with one surface of the second resin layer on a side oppositely away from the other surface thereof, which is contacted with the functional layer. The first and second supports have elastic moduli larger than those of the first and second resin layers. One of the first and second supports is omissible when the one support is replaced with an external support having an elastic modulus not smaller than that of the one support.

### CROSS REFERENCES TO RELATED APPLICATIONS

The present application claims priority to Japanese Patent Application JP 2010-081465 filed on Mar. 31, 2010, the entire contents of which is hereby incorporated by reference.

### BACKGROUND

The present disclosure relates to a functional laminate suitably used as, e.g., an optical functional film, which selectively and directionally reflects light in a specific wavelength range, but which transmits light other than the specific wavelength range therethrough. The present invention also relates to a functional structure including the functional laminate.

Recently, an optical layer partly absorbing or reflecting the sunlight has been coated on architectural glasses for high-rise buildings and housings, vehicular window glasses, etc. in increasing cases. Such an optical layer serves to prevent the indoor temperature from rising overly with the sunlight coming into the indoor through windows. Optical energy coming from the sun is primarily made up of energy of light in a visible range at wavelengths of 380 to 780 nm and light in a near infrared range at wavelengths of 780 to 2100 nm. Human eyesight is not impaired even when, of the lights in the visible and near infrared ranges, the light in the near infrared range is blocked. To obtain not only high transparency and visibility, but also a high level of heat rejection property simultaneously, therefore, it is important to limit transmission (passage) of the light in the near infrared range through the optical layer.

The demand for blocking the light in the near infrared range while maintaining transparency to the light in the visible range can be realized by providing a layer having absorbance that is selectively high to the light in the near infrared range, or by providing a layer having reflectance that is selectively high to the light in the near infrared range.

Regarding the provision of the absorbing layer, many techniques of providing organic-based dye films are proposed. However, when such a dye film is affixed to a window glass, light absorbed by the dye film is converted to heat in the window surface, and part of the heat is transmitted as radiant heat to the indoor. This causes a problem that the thermal rejection property tends to be insufficient. Another problem is in that, because of a risk of glass breakage due to thermal stress and low weatherbility of the dye film, the technique using the dye film has a difficulty in application to, e.g., high-rise buildings in which the dye film is hard to frequently replace.

Regarding the provision of the reflecting layer, many techniques of providing, e.g., an optical multilayer film, a metal-containing film, and a transparent electroconductive film, are proposed. However, when the reflecting layer is provided on a flat window glass, the sunlight incoming from above is specularly (regularly) reflected so as to advance downward. Upon reaching other buildings and the ground, the reflected light is absorbed there and converted to heat, thereby raising the ambient temperature. In the surroundings of the building in which the above-mentioned reflecting layer is affixed to all windows, therefore, a local temperature rise occurs, thus causing new environmental problems due to thermal pollution, such as that a heat island phenomenon is accelerated, and that grass is not grown in an area irradiated with the reflected light.

Meanwhile, retroreflection sheets have been recently used in a variety of applications including, e.g., road signs. The term “retroreflection” implies such reflection that incident light is reflected to be guided toward a generation source of the incident light again, and it is one type of directional reflection. The term “directional reflection” implies such reflection that incident light is reflected in a specific direction other than the direction of specular reflection (i.e., of reflection where an incidence angle and a reflection angle are equal to each other), and that the intensity of reflected light is sufficiently stronger than the intensity of diffuse-reflected light having no directivity. When a reflection surface is one flat plane oriented in a certain direction, there occur specular reflection and diffuse reflection, the latter being caused by irregularities in smoothness of the reflection surface. On the other hand, when a reflection surface is made up of many small surfaces oriented in different directions with certain regularity, incident light may repeat specular reflection at the small surfaces plural times, thus giving rise to directional reflection.

As materials for the retroreflection sheet, there are two types, i.e., a bead-added sheet material and a cube corner sheet material. In the bead-added sheet material, a large number of tiny spheres made of glass or ceramic are used to retroreflect the incident light. In the cube corner sheet material, a large number of hard interconnected cube-corner elements are typically used to retroreflect the incident light.

FIG. 19A is a sectional view illustrating one example 100 of the cube corner (retroreflection) sheet material disclosed in Japanese Patent No. 3623506 (claim 1, page 5, and FIGS. 1 and 2), and FIG. 19B is a plan view illustrating a rear surface 120 (i.e., a surface on the opposite side relative to a light incident surface) of a cube corner element. Japanese Patent No. 3623506 states as follows.

The cube corner sheet material 100 includes a large number of cube corner elements 112 and a body portion 114. The body portion 114 includes a land layer 116 and a body layer 118. The body layer 118 serves as a support for supporting entire integrality of the sheet material 100. The land layer 116 is distinct from the body layer 118 in that it is disposed adjacent to bases for the cube corner elements 112.

The cube corner elements 112 are projected from the rear surface 120 of the body portion 114. As illustrated in FIG. 19B, the cube corner elements 112 are regularly and symmetrically arranged on the rear surface 120. Each of the cube corner elements 112 is in the form of a three-sided prism having exposed flat surfaces 122a, 122b and 122c. In many cases, the three-sided prism has a triangular conical shape having one apex of a cube and three apexes closest to the former one apex. The flat surfaces 122a, 122b and 122c are orthogonal to one another (this requirement is not necessitate in all cases). Incident light enters the cube corner sheet material 100 at a front surface 121 thereof, passes through the body portion 114, and impinges against one flat surface 122 of the cube corner element 112. Then, the incident light returns to the incident direction after being reflected by each of the flat surfaces 122a, 122b and 122c, i.e., after repeating reflection three times in total.

In some cases, the retroreflection sheet material (cube corner sheet material) 100 is applied to a concave-convex surface and a flexible surface. Therefore, Japanese Patent No. 3623506 proposes a retroreflection sheet material in which the body layer 118 includes a polymeric material with an elastic modulus smaller than 7×10⁸ Pa and the cube corner element 112 includes a polymeric material with an elastic modulus of 1.6×10⁹ Pa or larger so that the retroreflection sheet material has good retro-reflectivity even when it is bent following the shape of an adherend (affixing target). Further, in one preferable embodiment disclosed in Japanese Patent No. 3623506, the cube corner element 112 and the land layer 116 are formed of analogous polymers or the same polymer.

Japanese Unexamined Patent Application Publication No. 2007-10893 (claim 2, paragraphs 0040 to 0043, and FIGS. 1 and 2) proposes, as one example, a transparent wavelength-selective retroreflector comprising an optical structural layer made of a light transmissive material and having a substantially flat front surface and a rear surface provided with a cube corner retroreflection structure, a wavelength-selective reflecting layer disposed on the rear surface of the optical structural layer, allowing visible light to pass therethrough, and selectively reflecting light in a specific wavelength range other than the visible light, and a light transmissive resin layer disposed on a surface of the wavelength-selective reflecting layer on the side oppositely away from the optical structural layer.

The proposed transparent wavelength-selective retroreflector is fabricated by forming the wavelength-selective reflecting layer, which includes a polymer material layer, an inorganic material layer made of, e.g., lithium fluoride, and a transparent electroconductive layer made of, e.g., ITO (indium tin compound oxide), etc., on the rear surface of the optical structural layer, the rear surface being provided with the cube corner retroreflection structure.

By employing the directional reflector having wavelength selectivity, which is proposed in, e.g., Japanese Unexamined Patent Application Publication No. 2007-10893, it is presumably possible to form a reflecting layer, which has a reflectance selectively high to light in the near infrared range, and which directionally reflects light incoming from above upward instead of specularly reflecting the light downward. It is therefore thought that, by affixing such a reflecting layer to window glasses, the problem of causing thermal pollution in ambient environments with the reflected light can be avoided while preventing an excessive rise of the temperature in the indoor, which is caused with the sunlight coming into the indoor through windows. Further, it is thought that a point of compromise between the prevention of the temperature rise in the indoor and the avoidance of the thermal pollution in the ambient environments can also be found by providing a reflecting layer, which has a semi-reflection (half-mirror) characteristic and which reflects some percentage of the light in the near infrared range.

### SUMMARY

In the process of manufacturing the directional reflector or the semi-reflection (half-mirror) layer having wavelength selectivity, however, the following problem is confirmed. The wavelength-selective reflecting layer may be peeled off or large cracks may be generated to damage the reflecting surface due to, e.g., forces exerted during the manufacturing process and expansion/contraction caused by temperature changes, whereby the function of the wavelength-selective reflecting layer is degraded to a large extent. FIG. 20 illustrates an image obtained by observing, with an optical microscope, the wavelength-selective reflecting layer that is partly peeled off from the cube-corner type optical structural layer in the directional reflector, e.g., the transparent wavelength-selective retroreflector proposed in Japanese Unexamined Patent Application Publication No. 2007-10893.

In view of the above-described situations in the art, it is desirable to provide a functional laminate suitably used as, e.g., an optical functional film, which selectively and directionally reflects or semi-reflects light in a specific wavelength range, but which transmits light other than the specific wavelength range therethrough, the functional laminate being less susceptible to damage with, e.g., external forces and expansion/contraction caused by temperature changes, and to provide a functional structure including the functional laminate.

According to an embodiment, there is provided a functional laminate including a functional layer including an inorganic layer formed in a predetermined three-dimensional shape, a first resin layer and a second resin layer disposed in close contact with two principal surfaces of the functional layer, respectively, and sandwiching the functional layer therebetween, and a first support and a second support disposed respectively in contact with one surface of the first resin layer on a side oppositely away from the other surface thereof, which is in contact with the functional layer, and with one surface of the second resin layer on a side oppositely away from the other surface thereof, which is in contact with the functional layer, the first support and the second support having elastic moduli larger than elastic moduli of the first resin layer and the second resin layer, one of the first support and the second support being omissible when the one support is replaced with an external support having an elastic modulus equal to or larger than the elastic modulus of the one support.

According to another embodiment, there is provided a functional structure including the above-described functional laminate.

With the functional laminate according to the embodiment, the functional layer is sandwiched between the first support and the second support with the first resin layer and the second resin layer interposed respectively between the functional layer and the first and second resin layers. Further, the first support and the second support have the elastic moduli larger than those of the first resin layer and the second resin layer. Thus, the functional layer is positioned between two supports, which are comparatively hard to deform, in such a state as wrapped with cushioning materials. Accordingly, even when an external force is exerted on the functional laminate, the external force is first borne by the first support and the second support, which are comparatively hard to deform. Hence, deformations and stresses caused inside the functional laminate can be held small. Deformations and stresses caused nevertheless are moderated by the first resin layer and the second resin layer, which are more apt to deform than the first support and the second support. Therefore, deformations and stresses acting on the functional layer are further reduced. Similarly, stresses generated due to expansion/contraction caused by temperature changes, for example, are also moderated by the first resin layer and the second resin layer. As a result, in the functional laminate according to the embodiment, the functional layer is less susceptible to damage with, e.g., the external forces and the expansion/contraction caused by temperature changes.

The functional structure according to the embodiment has similar advantages to those described above because it includes the functional laminate.

Additional features and advantages are described herein, and will be apparent from the following Detailed Description and the figures.

### BRIEF DESCRIPTION OF THE FIGURES

FIGS. 1A and 1B are each a sectional view illustrating the structure of a functional laminate according to a first embodiment;

FIGS. 2A to 2D are sectional views illustrating the flow of a fabrication process for the functional laminate according to the first embodiment;

FIGS. 3A to 3C are sectional views illustrating the flow of the fabrication process for the functional laminate according to the first embodiment;

FIG. 4A is a perspective view illustrating an example of the shape of a functional layer according to the first embodiment, and FIG. 4B is a sectional view illustrating the function of the functional layer;

FIG. 5 is a perspective view illustrating another example of the shape of the functional layer according to the first embodiment;

FIG. 6A is a plan view illustrating still another example of the shape of the functional layer according to the first embodiment, and FIG. 6B is an enlarged sectional view taken along a line VIB-VIB in FIG. 6A;

FIG. 7 is a perspective view illustrating the relationship between incident light entering the functional laminate and light reflected by the functional laminate according to the first embodiment;

FIG. 8 is a sectional view illustrating the structure of a functional laminate according to a first modification;

FIGS. 9A to 9C are each a sectional view illustrating the structure of a functional laminate according to a second modification;

FIG. 10A is a perspective view illustrating the shape of a functional layer according to a third modification, and FIG. 10B is a sectional view illustrating the function of the functional layer according to the third modification;

FIG. 11A is a perspective view illustrating the shape of a functional layer according to a fourth modification, and FIG. 11B is a sectional view illustrating the function of the functional layer according to the fourth modification;

FIG. 12 is a perspective view illustrating the shape of a functional layer according to a fifth modification:

FIG. 13A is a plan view illustrating a two-dimensional array in a functional layer according to a sixth modification, and FIGS. 13B and 13C are sectional views taken along lines XIIIB-XIIIB and XIIIC-XIIIC in the plan view of FIG. 13A, respectively;

FIG. 14A is a plan view illustrating a two-dimensional array in a functional layer according to a seventh modification, and FIGS. 14B and 14C are sectional views taken along lines XIVB-XIVB and XIVC-XIVC in the plan view of FIG. 14A, respectively;

FIG. 15A is a perspective view illustrating the structure of a window blind (shade) according to a second embodiment, and FIG. 15B is a sectional view of a slat;

FIG. 16A is a perspective view illustrating the structure of a rolling screen device according to the second embodiment, and FIG. 16B is a sectional view of a screen;

FIG. 17A is a perspective view illustrating the structure of a fitting according to the second embodiment, and FIG. 17B is a sectional view of an optical functional body;

FIG. 18 is a graph plotting test results of the embodiments and comparative examples;

FIG. 19A is a sectional view illustrating one example of a cube-corner retroreflection sheet material disclosed in Japanese Patent No. 3623506, and FIG. 19B is a plan view illustrating a rear surface (i.e., a surface on the opposite side relative to a light incident surface) of a cube corner element; and

FIG. 20 is an image that is observed by a microscope and that indicates peeling-off of a wavelength-selective reflecting layer, the peeling-off being found in a directional reflector, e.g., a transparent wavelength-selective retroreflector proposed in Japanese Unexamined Patent Application Publication No. 2007-10893.

### DETAILED DESCRIPTION

The present application will be described in detail in reference to the drawings according to an embodiment.

In the functional laminate according to the embodiment, preferably, the first support or the second support is omitted, and the first resin layer or the second resin layer is affixed to the external support having the elastic modulus larger than the elastic moduli of the first resin layer and the second resin layer.

Preferably, the elastic moduli of the first support and the second support measured in conformity with JIS 7161 are in a range of 7×10⁸ to 7.2×10¹⁰ Pa at 25° C.

Preferably, the first resin layer and the second resin layer are made of the same material.

Preferably, the functional laminate is an optical functional laminate having a light incident surface provided by a surface of the first support and reflecting, absorbing, semi-transmitting, or transmitting incident light.

In such a case, preferably, the functional layer is an optical functional layer having a directional reflection property. For example, preferably, a reflecting surface of the functional layer is made up of reflecting surface groups including a group of many first reflecting surfaces and a group of many second reflecting surfaces. Further, the first reflecting surfaces and the second reflecting surfaces are each formed in an elongate rectangular shape in a plan view such that long sides of the first and second reflecting surfaces are equal to each other and are parallel to the light incident surface, while short sides of the first and second reflecting surfaces are inclined at a certain angle with respect to the light incident surface. Still further, the many first reflecting surfaces and the many second reflecting surfaces are alternately arrayed in a one-dimensionally cyclic pattern in a direction perpendicular to a lengthwise direction of the reflecting surfaces.

As another example, preferably, the reflecting surface of the functional layer is made up of many unit recesses or unit projections that are regularly arrayed, and a three-dimensional shape of the unit recesses or unit projections is pyramidal, conical, semi-spherical, or cylindrical.

In the optical functional layer having the directional reflection property, preferably, a surface direction of a symmetrical plane or a direction of a symmetrical axis of the reflecting surface of the functional layer, the direction providing a direction in which retro-reflectance is exactly or substantially maximized, is inclined from a direction perpendicular to the incident surface.

As an alternative, preferably, a reflecting surface of the functional layer is constituted by a reflecting surface group including one type of many individual reflecting surfaces. Further, the reflecting surfaces are each formed in an elongate rectangular shape in a plan view such that long sides of the reflecting surfaces are parallel to the light incident surface, while short sides of the reflecting surfaces are inclined at a certain angle with respect to the light incident surface. Still further, the many reflecting surfaces are arrayed in a one-dimensionally cyclic pattern in a direction perpendicular to a lengthwise direction of the reflecting surfaces.

Preferably, the functional laminate is an optical functional laminate selectively reflecting, absorbing, semi-transmitting, or transmitting incident light in a specific wavelength range. In particular, preferably, the functional layer is an optical functional layer selectively reflecting or transmitting the incident light in the specific wavelength range. In such a case, preferably, the functional layer is made up of plural layers including a high refractive-index layer and a metal layer, which are laminated, or made up of plural layers including a low dielectric-constant layer and a high dielectric-constant layer, which are alternately laminated. As an alternative, preferably, the functional layer is a transparent electroconductive layer containing, as a main component, an electroconductive material that has transparency in a visible range, or a functional layer containing, as a main component, a chromic material having reflective performance that is reversibly changed upon application of an external stimulus.

Preferably, the functional laminate further includes a layer that is formed on a surface of the functional laminate and that has a water-repellent or hydrophilic property.

The functional structure according to the embodiment preferably includes the optical functional laminate selectively reflecting, absorbing, semi-transmitting, or transmitting incident light, and it is constituted as a window member, a solar shading member, or a fitting.

Embodiments will be described concretely and in detail below with reference to the drawings.

### First Embodiment

The first embodiment is described in connection with examples of a functional laminate.

[Functional Laminate]

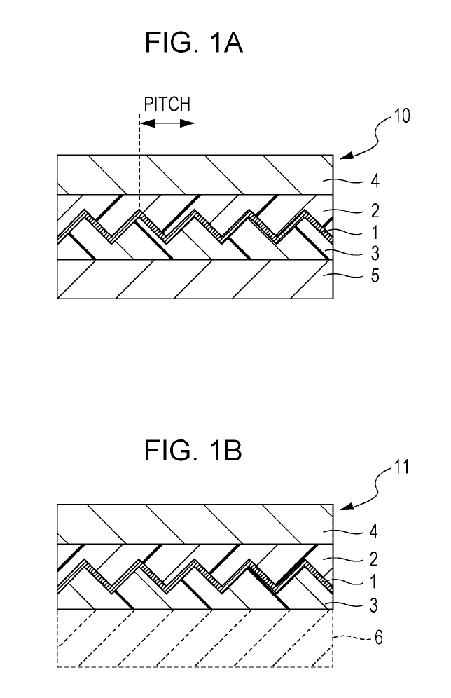

FIG. 1A is a sectional view illustrating the structure of a functional laminate 10 according to the first embodiment. The functional laminate 10 includes a functional layer 1, a first resin layer 2 and a second resin layer 3 disposed in close contact with two principal surfaces of the functional layer 1, respectively, and sandwiching the functional layer 1 therebetween, a first support 4 disposed in contact with one surface of the first resin layer 2 on the side oppositely away from the other surface thereof, which is in contact with the functional layer 1, and a second support 5 disposed in contact with one surface of the second resin layer 3 on the side oppositely away from the other surface thereof, which is in contact with the functional layer 1. The functional layer 1 includes an inorganic layer formed in a predetermined three-dimensional shape, and develops a specific function depending on the material, the layer structure, and the three-dimensional shape thereof.

The functional layer 1 is sandwiched between the first support 4 and the second support 5 with the first resin layer 2 and the second resin layer 3 interposed respectively between the functional layer 1 and the first and second resin layers 2, 3. Further, the first support 4 and the second support 5 have elastic moduli larger than those of the first resin layer 2 and the second resin layer 3. Thus, the functional layer 1 is positioned between two supports, which are comparatively hard to deform, in such a state as wrapped with cushioning materials. Accordingly, even when an external force is exerted on the functional laminate 10, the external force is first borne by the first support 4 and the second support 5, which are comparatively hard to deform. Therefore, deformations and stresses caused inside the functional laminate 10 can be held small. Deformations and stresses caused nevertheless are moderated at the interface between the first support 4 and the first resin layer 2, the latter being more apt to deform than the former, and at the interface between the second support 5 and the second resin layer 3, the latter being more apt to deform than the former, as well as in the interiors of the first resin layer 2 and the second resin layer 3. Hence, deformations and stresses acting on the functional layer 1 are further reduced. Similarly, stresses generated due to expansion/contraction caused by temperature changes, for example, are also moderated by the first resin layer 2 and the second resin layer 3. As a result, in the functional laminate 10, the functional layer 1 is less susceptible to damage with, e.g., the external forces and the expansion/contraction caused by temperature changes. Conversely, if the first support 4 and the second support 5 have elastic moduli smaller than those of the first resin layer 2 and the second resin layer 3, stresses are concentrated between the functional layer 1 and the first resin layer 2 and between the functional layer 1 and the second resin layer 3, whereby interface breakage is more apt to occur. Though not necessitate requirements, the first support 4 and the second support 5 desirably satisfy the above-described conditions in both of the temperature range of use and the temperature range of a manufacturing process.

The elastic moduli of the first support 4 and the second support 5, measured in conformity with JIS 7161, are each preferably 7×10⁸ to 7.2×10¹⁰ Pa at 25° C. If the elastic modulus is smaller than 7×10⁸ Pa, a problem arises in that the support is undesirably deformed and the functional laminate is difficult to handle it. On the other hand, if the elastic modulus exceeds 7.2×10¹⁰ Pa, the functional laminate 10 is difficult to wind it into the form of a roll and is less convenient in manufacturing, transporting and storing, as well as utilizing it.

The first resin layer 2 and the second resin layer 3 are preferably made of the same type material. By using the same type material, dynamic balance is more easily taken between the first resin layer 2 and the second resin layer 3, and stresses exerted on the functional layer 1 are expected to be reduced.

FIG. 1B is a sectional view illustrating the structure of a functional laminate 11 according to a modification of the first embodiment. The functional laminate 11 is similarly constructed to the functional laminate 10 except that the second support 5 is omitted in the functional laminate 11. In the functional laminate 11, the second resin layer 3 is affixed to an external support 6. The external support 6 is a substance having an elastic modulus that is comparable to or larger than that of the second support 5 and that is larger than those of the first resin layer 2 and the second resin layer 3. For example, the external support 6 is a window glass. Preferably, the second resin layer 3 is affixed to the external support 6 with a bond or an adhesive (not shown) interposed therebetween, or it is itself a bond or an adhesive. While FIG. 1B illustrates the modification in which the second support 5 is omitted, the first support 4 may be omitted to be replaced with the external support 6.

[Fabrication of Functional Laminate]

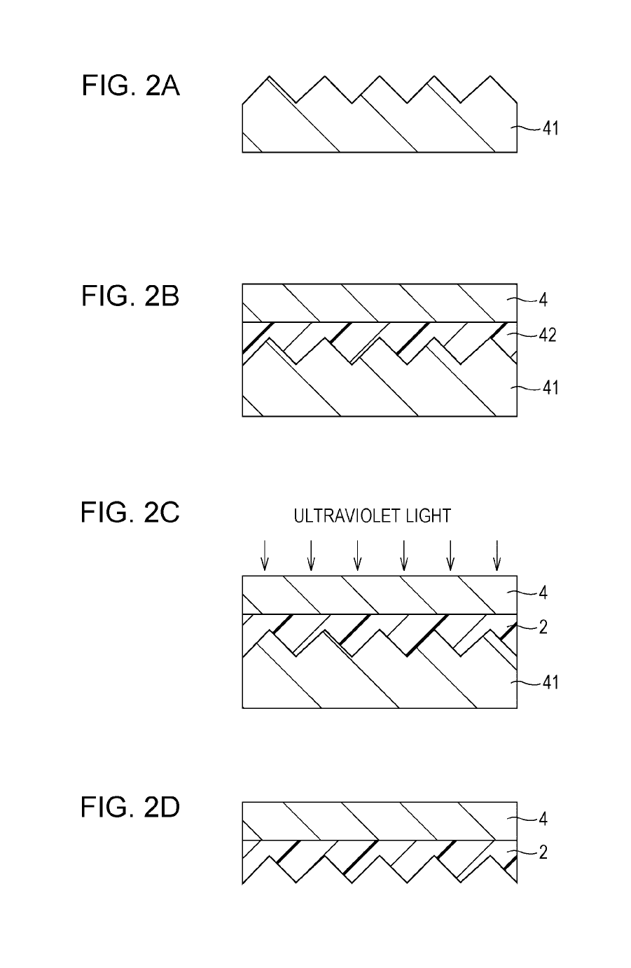

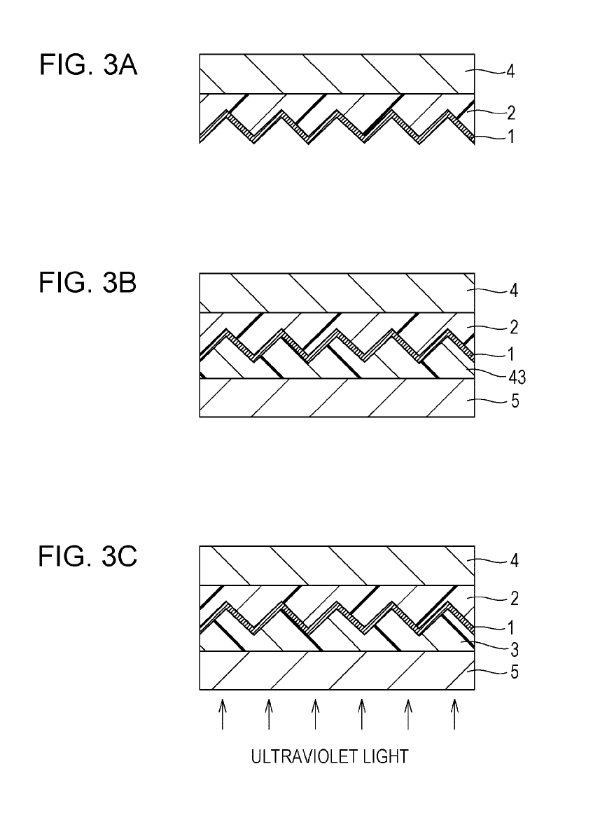

FIGS. 2A to 2D and FIGS. 3A to 3C are sectional views illustrating the flow of a fabrication process for the functional laminate 10 according to the first embodiment.

To fabricate the functional laminate 10, as illustrated in FIG. 2A, a predetermined three-dimensional shape is first formed on the surface of a die 41 by cutting with a bite or a laser machining The predetermined three-dimensional shape is formed to be the same as a three-dimensional shape of the functional layer 1 to be fabricated, or in a shape reversed to the latter in a concave-convex relation. In this embodiment, the description is made on condition that both the three-dimensional shapes are the same.

Next, as illustrated in FIG. 2B, a first resin material layer 42 is formed on the surface of the die 41 by, e.g., a suitable application method. The first resin material layer 42 is a layer that is made of a still-uncured resin monomer and/or oligomer and that is changed into the first resin layer 2 when cured. The first support 4 in the form of a film having a thickness of, e.g., about 100 μm is then pressed onto the first resin material layer 42 such that the die 41, the first resin material layer 42, and the first support 4 are brought into a closely contacted state.

Next, as illustrated in FIG. 2C, the first resin material layer 42 is irradiated with ultraviolet light from the side including the first support 4 to cure the resin monomer and/or oligomer, thereby forming the first resin layer 2.

Next, as illustrated in FIG. 2D, a laminate of the first support 4 and the first resin layer 2 is peeled off from the die 41 to obtain the first resin layer 2 to which the three-dimensional shape of the surface of the die 41 is reversely transferred. While the illustrated example employs a method using an ultraviolet curable resin as the material of the first resin layer 2, the first resin layer 2 may be formed by using a thermoplastic resin as the material of the first resin layer 2, pressing the first resin material layer 42 onto the die 41 while heating it to temperature higher than the glass transition temperature of the thermoplastic resin, cooling the first resin material layer 42 to temperature lower than the glass transition temperature of the thermoplastic resin, and then peeling off the first resin layer 2 from the die 41.

Next, as illustrated in FIG. 3A, the functional layer 1 is formed in close contact with the surface of the first resin layer 2. As a result, one principal surface of the functional layer 1, which is in close contact with the first resin layer 2, is formed in the same shape as the three-dimensional shape of the surface of the die 41. A method for forming the functional layer 1 is not limited to particular one and can be optionally selected from various methods, such as vapor deposition, sputtering, chemical vapor deposition (CVD), coating, and dipping, depending on the material used and the shape of the functional layer 1.

Next, as illustrated in FIG. 3B, a second resin material layer 43 is formed on the other principal surface of the functional layer 1 by, e.g., a suitable application method. The second resin material layer 43 is a layer that is made of a still-uncured resin monomer and/or oligomer and that is changed into the second resin layer 3 when cured. After pushing out bubbles from the second resin material layer 43, the second support 5 in the form of a film having a thickness of, e.g., about 100 μm is pressed onto the second resin material layer 43 such that the functional layer 1, the second resin material layer 43, and the second support 5 are brought into a closely contacted state.

Next, as illustrated in FIG. 3C, the second resin material layer 43 is irradiated with ultraviolet light from the side including the second support 5 to cure the resin monomer and/or oligomer, thereby forming the second resin layer 3. As a result, the functional laminate 10 is obtained. While the illustrated example employs a method using an ultraviolet curable resin as the material of the second resin layer 3, the second resin layer 3 may be formed by using a thermoplastic resin as the material of the second resin layer 3, pressing the second resin material layer 43 onto the functional layer 1 while heating it to temperature higher than the glass transition temperature of the thermoplastic resin, and then cooling the second resin material layer 43 to temperature lower than the glass transition temperature of the thermoplastic resin.

The functional laminate 11 can be obtained by performing the steps, which are illustrated in FIGS. 3B and 3C, in a state where a peeling film is coated on the second support 5, and then peeling off the second support 5 from the cured second resin layer 3 at the peeling film.

[Optical Functional Laminate]

The functional laminate 10 or 11 is not particularly limited in the structure except that the predetermined three-dimensional shape of the functional layer 1 is necessitate to develop the function of the functional laminate. Typically, the functional laminate 10 or 11 is an optical functional laminate that reflects, absorbs, semi-transmits, or transmits incident light. In such a case, in particular, the functional layer 1 is preferably an optical functional layer having directional reflectivity. More preferably, the functional laminate 10 or 11 is an optical functional laminate that selectively reflects, absorbs, semi-transmits, or transmits incident light in a specific wavelength range. In such a case, in particular, the functional layer 1 is preferably an optical functional layer that selectively reflects or transmits the incident light in the specific wavelength range.

Various members, etc. of the functional laminate 10 will be described in detail below in connection with an example where the functional layer 1 selectively and directionally reflects the light in the specific wavelength range, but it transmits light other than the specific wavelength range therethrough, and where the functional laminate 10 is formed as an optical functional film selectively and directionally reflecting the light in the specific wavelength range, but transmitting light other than the specific wavelength range therethrough. The following description is similarly applied to the case where the functional laminate 10 is replaced with the functional laminate 11.

In that case, it is particularly preferable that the selectively and directionally reflected light is near infrared light, and the transmitted light is visible light. As described above, the optical layer partly reflecting the sunlight has been coated on window glasses, etc. in increasing applications in order to prevent the indoor temperature from rising overly with the sunlight coming into the indoor through windows. Optical energy coming from the sun is primarily made up of energy of light in the visible range and light in the near infrared range. Human eyesight is not impaired even when, of the lights in the visible and near infrared ranges, the light in the near infrared range is blocked. To obtain not only high transparency and visibility, but also a high level of heat rejection property simultaneously, therefore, it is important to limit transmission (passage) of the light in the near infrared range through the optical layer. Affixing the optical functional film, which selectively retroreflects the near infrared light, to the window glass is advantageous in realizing such a demand without causing thermal pollution in the surroundings.

<Shape of Functional Layer>

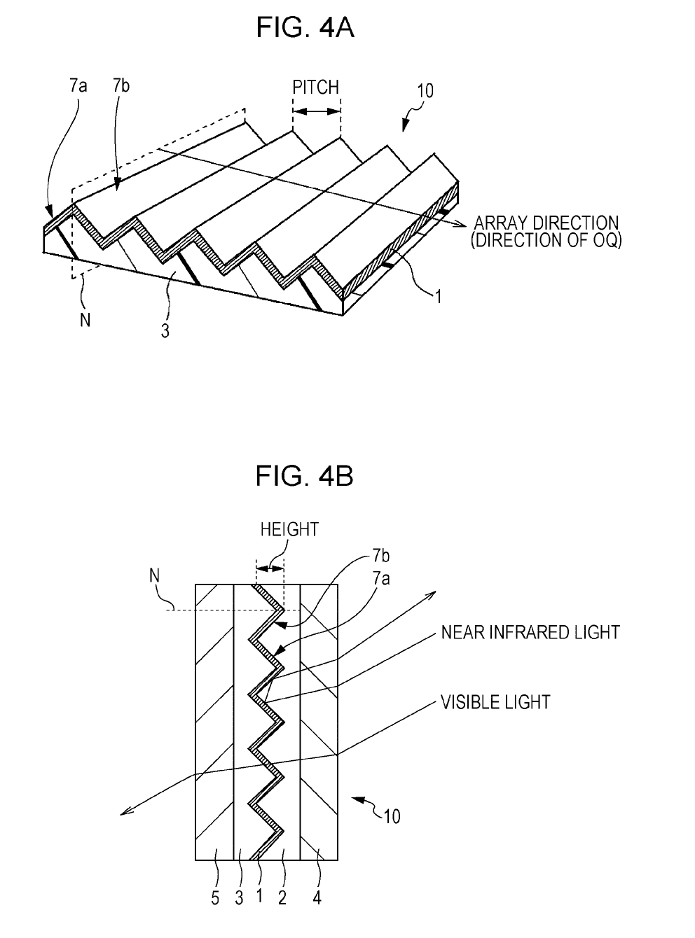

FIG. 4A is a perspective view illustrating an example of the shape of the functional layer 1 in the functional laminate 10. For simpler representation and easier understanding, only the functional layer 1 and the second resin layer 3 are illustrated in FIG. 4A. A reflecting surface of the functional layer 1 is constituted as a reflecting surface group, which includes two types of many reflecting surfaces 7a and 7b. Those many reflecting surfaces 7a and 7b are alternately arrayed side by side in one direction, i.e., in a one-dimensionally cyclic pattern. The reflecting surfaces 7a and 7b each have an elongate rectangular shape in a plan view, and their sizes are equal to each other. Long sides of each of the reflecting surfaces 7a and 7b are formed parallel to a light incident surface (e.g., the surface of the first support 4; see FIG. 4B), while short sides thereof are formed to be inclined at a certain angle with respect to the light incident surface. A plane N bisecting an angle formed by the reflecting surfaces 7a and 7b adjacent to each other is perpendicular to the light incident surface, and the reflecting surfaces 7a and 7b are symmetrical with respect to the plane N. Many pairs of the symmetrically formed reflecting surfaces 7a and 7b are arrayed side by side in one direction, i.e., in a one-dimensionally cyclic pattern, which is perpendicular to the lengthwise direction of the reflecting surface 7, thereby constituting the entire reflecting surface of the functional layer 1. Accordingly, the reflecting surfaces 7a and 7b of the functional layer 1 have inversion symmetry in the one-dimensional array direction. Such a symmetrical shape of the functional layer 1 is referred to as a “V-groove shape” hereinafter. The angle formed between the reflecting surfaces 7a and 7b is not limited to a particular value, but it is typically 90°. In the latter case, when the reflecting surfaces 7a and 7b are cut in a plane parallel to the array direction, they are given as two short sides forming a right angle of a rectangular equilateral triangle. While a V-groove is formed in the illustrated example, the groove may have a U-shape.

A pitch of the array of the reflecting surfaces 7a and 7b is preferably 5 μm to 5 mm, more preferably 10 to 250 μm, and even more preferably 20 to 200 μm. When the pitch is 250 μm or smaller, flexibility is increased to such an extent that the functional laminate can be easily manufactured by using a roll-to-roll process, and productivity is increased in comparison with the case of manufacturing the functional laminate with a batch process. When the optical functional film of this embodiment is applied to building materials (members) such as window glasses, a length of the optical functional film is about several meters in many cases and the roll-to-roll process is more suitable to manufacture the long optical functional film than the batch process. By setting the pitch to be from 20 to 200 μm, flexibility is further increased and so is productivity.

Meanwhile, if the pitch is smaller than 5 μm, part of the light of the transmission wavelength may be reflected in some cases because of difficulties in obtaining the desired shape of the functional layer 1 and in sharpening a wavelength selection characteristic thereof. The occurrence of the above-described partial reflection leads to such a tendency as generating diffraction and causing even higher-order reflections to be visually recognized, thus making a viewing person feel poorer in transparency. Conversely, if the pitch exceeds 5 mm, the thickness of the functional layer 1 is increased and flexibility is lost, thus raising a difficulty in affixing the functional laminate to a rigid body, such as a window glass.

A mean thickness of the functional layer 1 is preferably 20 μm or smaller, more preferably 5 μm or smaller, and even more preferably 1 μm or smaller. If the mean thickness of the functional layer 1 exceeds 20 μm, the length of an optical path in which the transmitted light is refracted is increased, and a transmission image tends to distort in appearance.

FIG. 4B is a sectional view illustrating the function of the functional layer 1. For simpler representation and easier reading, the first resin layer 2 and the second resin layer 3 are illustrated without hatching. The surface of the first support 4 is flat. One surface of the first resin layer 2 on the side oppositely away from the side contacting with the functional layer 1 is also flat. In the functional laminate 10, the flat surface of the first support 4 (or the flat surface of the first resin layer 2 when the first support 4 is omitted) serves as a light incident surface. When the functional layer 1 is made of the material and/or the layer structure selectively reflecting near infrared light, the near infrared light incident on the reflecting surface of the functional layer 1 is usually specularly reflected once for each of the reflecting surfaces 7a and 7b, i.e., twice in total, and then retroreflected toward the light source side. On the other hand, visible light simply passes through the functional layer 1. In the case of the functional layer 1, because a symmetry plane of the reflecting surfaces 7, i.e., the bisecting plane N, is perpendicular to the optical incident surface, retro-reflectance is maximized in the direction perpendicular to the incident surface.

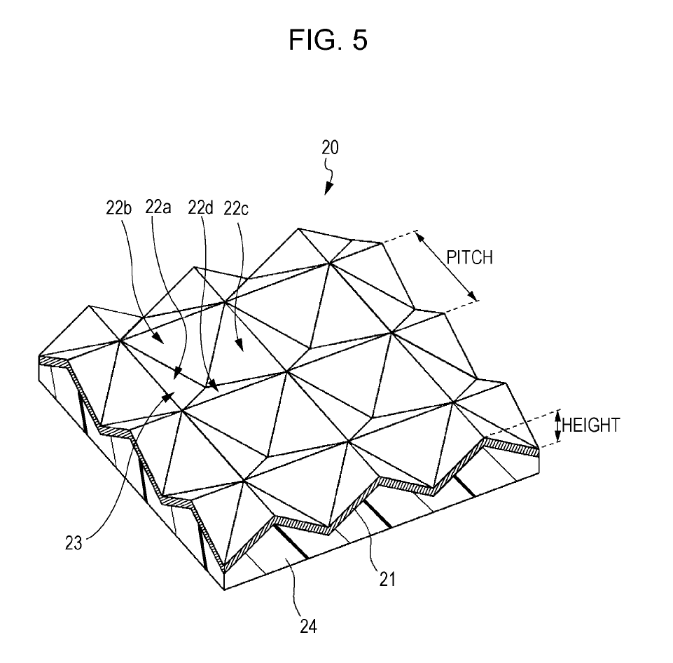

FIG. 5 is a perspective view illustrating another example of the shape of the functional layer. For simpler representation and easier understanding, only a functional layer 21 and a second resin layer 24 of a functional laminate 20 are illustrated in FIG. 5. A reflecting surface of the functional layer 21 is made up of many unit recesses 23 that are regularly arrayed. One unit recess 23 has reflecting surfaces 22a to 22d. The rear side of the functional layer 21 has the same shape as that obtained by successively forming the V-groove, illustrated in FIG. 4A, in two lengthwise and widthwise directions perpendicular to each other (namely, it has a shape obtained by regularly arraying many quadrangular pyramids). Such a shape of the functional layer 21 is referred to as a “double V-groove shape” hereinafter. When the functional layer 21 is made of the material and/or the layer structure selectively reflecting near infrared light, the near infrared light incident on the reflecting surface of the functional layer 21 is usually specularly reflected once for each of the reflecting surfaces 22a and 22c or the reflecting surfaces 22b and 22d, i.e., twice in total, and then retroreflected toward the light source side. On the other hand, visible light simply passes through the functional layer 21.

While the reflecting surface is formed with the recesses 23 in the above-described example, the reflecting surface may be formed with projections reversed to the recesses 23 in a concave-convex relation. In such a case, the near infrared light is usually specularly reflected once for each of opposed reflecting surfaces of two adjacent quadrangular pyramids, i.e., twice in total, and then retroreflected toward the light source side.

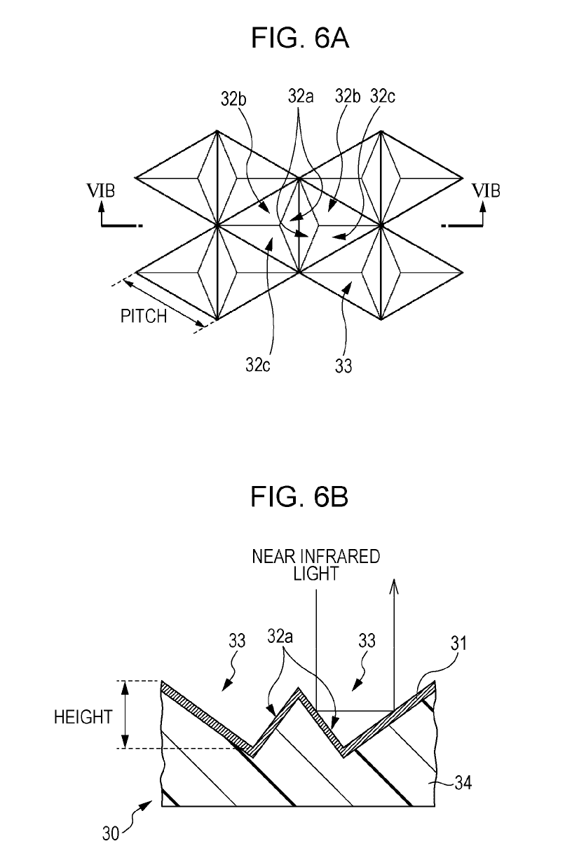

FIG. 6A is a plan view illustrating still another example of the shape of the functional layer, and FIG. 6B is an enlarged sectional view taken along a line VIB-VIB in FIG. 6A. For simpler representation and easier understanding, only a functional layer 31 and a second resin layer 34 are illustrated in the sectional view of FIG. 6B. A reflecting surface of the functional layer 31 is made up of many unit recesses 33 that are regularly arrayed and that are each in the form of a corner cube. One corner-cube unit recess 33 has reflecting surfaces 32a to 32c. The rear side of the functional layer 31 has the same shape as that obtained by successively forming the V-groove, illustrated in FIG. 4A, in three directions crossing at 60° (namely, it has a shape obtained by regularly arraying many triangular pyramids). Such a shape of the functional layer 31 is referred to as a “corner cube shape” hereinafter. When the functional layer 31 is made of the material and/or the layer structure selectively reflecting near infrared light, the near infrared light incident on the reflecting surface of the functional layer 31 is specularly reflected at least twice, specifically three times in total, i.e., once for each of the reflecting surfaces 32a, 32b and 32c in usual cases, and then retroreflected toward the light source side, as illustrated in FIG. 6B. On the other hand, visible light simply passes through the functional layer 31.

While the reflecting surface is formed with the recesses 33 in the above-described example, the reflecting surface may be formed with projections reversed to the recesses 23 in a concave-convex relation. In such a case, the near infrared light is usually specularly reflected once for each of opposed reflecting surfaces of two adjacent triangular pyramids, i.e., twice in total, and then retroreflected toward the light source side.

<Layer Structure and Materials of Functional Layer>

The functional layer 1, the functional layer 21, and the functional layer 31 illustrated in FIGS. 4 to 6, respectively, are each an optical functional layer that selectively reflects or transmits the incident light in the specific wavelength range. Such an optical functional layer can be constituted as a multilayer structure in which a high refractive-index layer and a metal layer are laminated, or a multilayer structure in which a low dielectric-constant layer and a high dielectric-constant layer are alternately laminated.

For example, when a transparent layer having a high refractive index in the visible range and functioning as an antireflection layer and a metal layer having a high reflectance in the infrared range are alternately laminated, a film (layer structure) having a high transmittance in the visible range and a high reflectance in the near infrared range can be formed. The metal layer having a high reflectance in the infrared range is, for example, a layer containing, as a main component, gold Au, silver Ag, copper Cu, aluminum Al, nickel Ni, chromium Cr, titanium Ti, palladium Pd, cobalt Co, silicon Si, tantalum Ta, tungsten W, molybdenum Mo, or germanium Ge alone, or an alloy containing two or more selected from among those elements. Of those examples, Ag, Cu, Al, Si or Ge is preferable as a single element in consideration of practicability. When an alloy is used, the metal layer preferably contains, as a main component, AlCu, Alti, AlCr, AlCo, AlNdCu, AlMgSi, AgPdCu, AgPdTi, AgCuTi, AgPdCa, AgPdMg, AgPdFe, Ag, or SiB, for example. To retard corrosion of the metal layer, the metal layer is preferably mixed with an additional material such as Ti or Nd. In particular, when Ag is used as the material of the metal layer, it is preferable to mix the additional material. The transparent layer contains, as a main component, a high-dielectric material, e.g., niobium oxide, tantalum oxide, or titanium oxide. A thin buffer layer made of, e.g., Ti and having a thickness of about several nanometers may be disposed at the interface between the transparent layer and the metal layer in order to prevent oxidation of the metal layer that is underlying when the transparent layer is formed. Herein, the term “buffer layer” implies a layer that is oxidized in itself to prevent oxidation of the metal layer when the transparent layer is formed.

Further, the film (layer structure) having a high transmittance for the visible light and a high reflectance for the near infrared light can also be formed by using a film including a low dielectric-constant layer and a high dielectric-constant layer, which are alternately laminated so as to constitute an interference filter.

<Other Functional Layers>

(1) Chromic Material Layer

When the functional layer 1 is formed by using a chromic material as a main component, an optical functional laminate can be obtained in which reflective performance, for example, is reversibly changed upon application of an external stimulus. The term “chromic material” implies a material reversibly changing its structure upon application of an external stimulus, such as heat, light, or intrusive molecules. Examples of the chromic material usable here include a thermochromic material that is colored with heat, an electrochromic material that is colored upon application of a voltage, a photochromic material that is colored with light, and a gaschromic material that is colored upon contacting with gas.

(2) Photonic Lattice Layer

A photonic lattice, such as a cholesteric liquid crystal, can also be used. The cholesteric liquid crystal can selectively reflect light of a wavelength depending on an interlayer distance, and the interlayer distance is changed depending on temperature. Therefore, the physical properties, such as reflectance and color, of the cholesteric liquid crystal can be reversibly changed upon heating. In this connection, a reflection band can be widened by using several types of cholesteric liquid crystals having different interlayer distances.

(3) Semi-Transmissive Layer

The functional layer 1 may be a semi-transmissive layer that directionally reflects some percentage of the incident light with less scattering, and that has such transparency as enabling the opposite side to be visually confirmed. The semi-transmissive layer is formed as, e.g., a metal layer made of a single layer or multiple layers and having semi-transparency. Similar materials to those of the metal layer of the above-described laminated film, for example, can also be used as materials of the metal layer that is formed on a structure. Several practical examples of the semi-transmissive layer are as follows:

(a) An AgTi layer with a thickness of 8.5 nm (mass ratio Ag:Ti=98.5:1.5)

(b) An AgTi layer with a thickness of 3.4 nm (mass ratio Ag:Ti=98.5:1.5)

(c) An AgNdCu layer with a thickness of 14.5 nm (mass ratio Ag:Nd:Cu=99.0:0.4:0.6)

The semi-transmissive layer can be formed by, e.g., sputtering, vapor deposition, dip coating, die coating, or another suitable method.

<First Resin Layer 2 and Second Resin Layer 3>

The elastic moduli of the first resin layer 2 and the second resin layer 3 are preferably 7.2×10¹⁰ Pa or smaller and more preferably 3.1×10⁹ Pa or smaller in the temperature range of about 25 to 60° C. so that the functional laminate 10 has flexibility. The glass transition temperatures of the first resin layer 2 and the second resin layer 3 are not factors particularly limiting their functions. In view of that the temperature of the resin surface is locally heated to high temperature when the metal layer or the oxide layer is formed by, e.g., sputtering or vapor deposition, however, the glass transition temperatures of the first resin layer 2 and the second resin layer 3 are desirably 60° C. or higher.

Materials having high light transmittances can be suitably used as the first resin layer 2 and the second resin layer 3. Examples of those materials include a polyvinyl acetal resin, a polyolefin resin, and a cellulose-based resin, and a styrene-based resin, which are used singly or in combination through, e.g., copolymerization. Alternatively, an ultraviolet curable resin may be used. In that case, a monomer and/or an oligomer having one or more (meth)acryloyl groups is preferably used as acrylate. Examples of such a monomer and/or an oligomer include urethane(meth)acrylate, epoxy(meth)acrylate, polyester(meth)acrylate, polyol(meth)acrylate, polyether(meth)acrylate, and melamine(meth)acrylate. Herein, the term “(meth)acryloyl group” implies an acryloyl group or a methacryloyl group. The term “oligomer” used herein implies a molecule having molecular weight of 500 or more to 60000 or less.

Further, an additive may be added to the first resin layer 2 and/or the second resin layer 3 for the purpose of increasing adhesion between the metal layer or the oxide layer, which constitutes the functional layer 1, and the resin. In this respect, when the metal layer or the oxide layer is susceptible to corrosion, a material having the least affinity to corrosive substances (such as moisture and halogens) is selected. In order to increase adhesion between the first resin layer 2 or the second resin layer 3 and the functional layer 1, the resin material preferably contains, e.g., a compound having a phosphono group, such as a (meth)acryl monomer derivative or oligomer derivative having a phosphono group. However, if a free inorganic phosphoric acid remains, it is crystallized and causes scattering of light. Accordingly, the materials are desirably selected or refined so that the concentration of inorganic phosphoric acid contained in the resin is desirably held to be 1.0% by mass or lower.

The first resin layer 2 and the second resin layer 3 are preferably made of the same resin having transparency in the visible range. Alternatively, the difference in refractive index between two materials constituting the first resin layer 2 and the second resin layer 3 is preferably 0.010 or less, more preferably 0.008 or less, and even more preferably 0.005 or less. If the difference in refractive index exceeds 0.010, the transmission image tends to blur in appearance. When the difference in refractive index is more than 0.008 and not more than 0.010, there are no problems in daily life though depending on outdoor brightness. When the difference in refractive index is more than 0.005 and not more than 0.008, the outdoor sight can be clearly viewed although only a very bright object, such as a light source, causes a displeasing diffraction pattern. When the difference in refractive index is 0.005 or less, the diffraction pattern is hardly displeasing. One of the first resin layer 2 and the second resin layer 3 on the side affixed to the external support 6, e.g., a window member, may contain an adhesive as a main component. In that case, the difference in refractive index with respect to the adhesive is preferably within the above-described range.

At least one of the first resin layer 2 and the second resin layer 3 may contain an additive. Examples of the additive include a photo-stabilizer, a flame retardant, an anti-oxidant, and an additive for increasing adhesion between the wavelength-selective reflecting film and the resin layer. Examples of the additive for increasing the adhesion include 2-acryloyloxyethyl acid phosphate (e.g., Light-Acrylate P-1A (trademark) made by KYOEISHA CHEMICAL Co., LTD., additive amount: 0.5 to 10% by mass), 2-methacryloyloxyethyl acid phosphate (e.g., Light-Acrylate P-2M (trademark) made by KYOEISHA CHEMICAL Co., LTD., additive amount: 2 to 10% by mass), 2-acryloyloxyethyl-succinic acid (e.g., HOA-MS (trademark) made by KYOEISHA CHEMICAL Co., LTD., additive amount: 20 to 50% by mass), and γ-butyrolactone methacrylate (e.g., GBLMA (trademark) made by Osaka Organic Chemical Industry Ltd., additive amount: 20 to 30% by mass). From the viewpoint of increasing the adhesion, the additive is preferably added in the amount satisfying the numerical range denoted above in the parenthesis. However, when the additive is added to only one of the first resin layer 2 and the second resin layer 3, the additive amount is preferably 3% by mass or less and more preferably 1% by mass or less to avoid such a phenomenon that the viewing sight is clouded due to the difference in refractive index and visibility on the opposite side becomes poor. In such a case, therefore, a phosphoric acid-based additive is preferably employed. The use of the phosphoric acid-based additive is effective in increasing transparency clarity. On the other hand, when the additive is added to both of the first resin layer 2 and the second resin layer 3, the amounts of the additives added to the first resin layer 2 and the second resin layer 3 are adjusted such that the difference in refractive index between both the layers is held as small as possible (preferably 0.010 or less).

<First Support 4 and Second Support 5>

Examples of materials suitably used for the first support 4 and the second support 5 include glass and resins, such as a cellulose-based resin, a polyester-based resin, a polyimide resin, a polyamide resin, an aramid resin, a polyolefin resin, a polyacrylate resin, a polyethersulfone resin, a polysulfone resin, a polyvinyl chloride resin, a polycarbonate resin, an epoxy resin, an urea resin, an urethane resin, and a melamine resin. However, the materials of both the supports are not particularly limited to the above-mentioned examples. In addition, the support may be subjected to surface treatment, or a thin resin layer may be formed on the support in order to increase adhesion between the support and the resin.

<Incident Direction of Incident Light and Reflection Direction of Reflected Light>

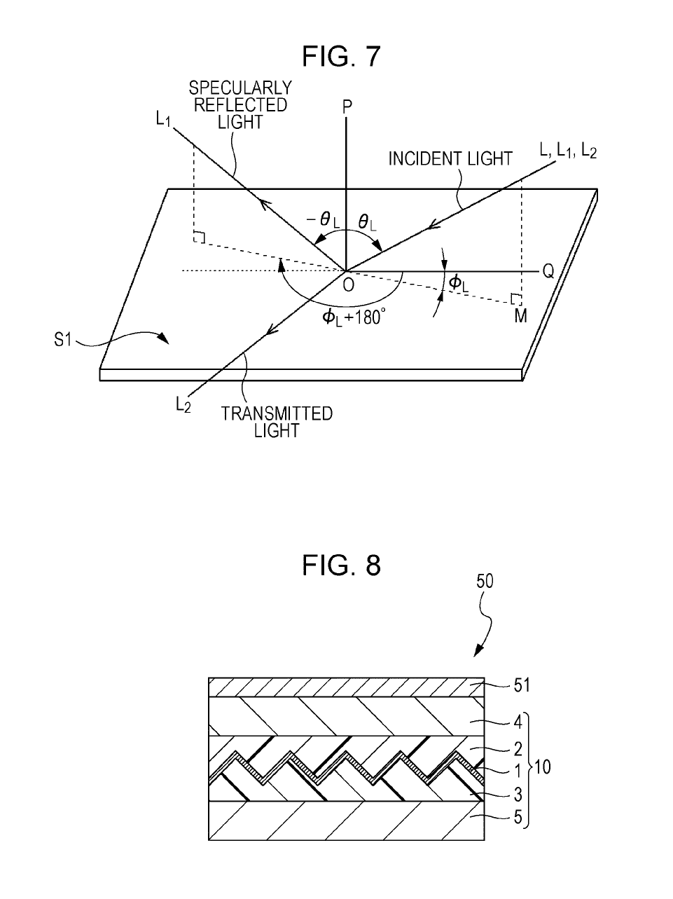

Definitions regarding how to represent the incident direction of the incident light and the reflection direction of the reflected light in the following description are clarified here. FIG. 7 is a perspective view illustrating the relationship between the incident direction of the incident light entering the functional laminate and the reflection direction of the light reflected by the functional laminate. The functional laminate has a flat incident surface S1 on which incident light L impinges. To represent the incident direction of the incident light and the reflection direction of the reflected light, two deflection angles θ and φ are defined as follows. A line drawn perpendicularly to the incident surface S1 from a point O where the incident light L enters the incident surface S1 is denoted by OP, and a specific half-line drawn on the incident surface S1 from the point O toward the light source side of the incident light L is denoted by OQ. A deflection angle formed by an arbitrary half-line starting from the point O with respect to the perpendicular line OP is denoted by θ. Further, a deflection angle of the incident light L from the perpendicular line OP is denoted by θ_{L} (0°≦θ_{L}≦90°), and a deflection angle of the direction symmetrical to the incident light L with respect to the perpendicular line OP is denoted by −θ_{L} (0°≧−θ_{L}≧−90°). A deflection angle (azimuth angle) of a half-line, which is obtained by projecting an arbitrary half-line starting from the point O onto the incident surface S1, with respect to the half-line OQ is denoted by φ. An angle rotated clockwise from the half-line OQ is defined to be positive, and an angle rotated counterclockwise from the half-line OQ is defined to be negative. An angle formed between a half-line OM, which is obtained by projecting the incident light L onto the incident surface S1, and the half-line OQ is denoted by φ_{L} (−90°≦φ_{L}≦90°). From the above definitions, the incident direction of the incident light L is represented by (θ_{L}, φ_{L}) by using a set (θ, φ) of the deflection angles θ and φ, and the specular reflection direction of the incident light L is represented by (−θ_{L}, φ_{L}+180°).

The direction of the specific half-line OQ is defined as a direction in which the light incident on the functional laminate 10 from a certain direction (azimuth) is directionally reflected in the same direction (azimuth) at maximum reflection intensity. However, when there are plural directions in which the reflection intensity is maximized, one of the plural directions is selected as the half-line OQ. In the functional laminate 10, for example, the one-dimensional array direction in the reflecting surface 7 of the functional layer 1, indicated by an arrow in FIG. 4A, or the direction reversed to the former is defined as the direction of the half-line OQ.

The functional laminate 10 selectively and directionally reflects, of the incident light L, light L₁ in a specific wavelength range in a direction other than the specular reflection direction, but it transmits light L₂ other than the specific wavelength range therethrough. Further, the functional laminate 10 preferably has transparency to the incident light L₂ and has transmission image clarity within the range described later. Herein, the expression “reflect” implies that the reflectance in a specific wavelength range, e.g., in the near infrared range, is preferably 30% or more, more preferably 50% or more, and even more preferably 80% or more. The expression “transmit” implies that the transmittance in a specific wavelength range, e.g., in the visible range, is preferably 30% or more, more preferably 50% or more, and even more preferably 70% or more.

The wavelength ranges of the incident light L₁ and the incident light L₂ are changed depending on the usage of the functional laminate 10. For example, when the functional laminate 10 is affixed to architectural glasses and wall members of, e.g., high-rise buildings and housings as an optical layer for absorbing or reflecting part of the sunlight, it is preferable that the incident light L₁ is near infrared and the incident light L₂ is visible light. More specifically, it is preferable that the incident light L₁ is near infrared light primarily having wavelength of 780 to 2100 nm. Optical energy coming from the sun is primarily made up of energy of light in a visible range at wavelengths of 380 to 780 nm and light in a near infrared range at wavelengths of 780 to 2100 nm. By reflecting the light in the near infrared range, the temperature inside the building can be prevented from rising overly with the optical energy coming from the sun. As a result, a cooling load can be reduced in summer and energy saving can be achieved. Depending on demanded characteristics, the incident surface S1 of the functional laminate 10 may have irregularities instead of being flat.

When the direction in which the incident light L₁ is directionally reflected is represented by (θ_{R}, φ_{R}), −90°≦φ_{R}≦90° (0≦θ_{R}) is preferably satisfied. On such a condition, when the functional laminate 10 is affixed to the external support 6 with the direction of OQ directing upward, the incident light L₁ incoming from above can be returned upward. When there are no high-rise buildings in the surroundings, the functional laminate 10 having such a characteristic is effectively utilized.

Further, the direction (θ_{R}, φ_{R}) of the directional reflection is preferably in the vicinity of (θ_{L}, −φ_{L}) or the vicinity of the direction of the retroreflection, i.e., (θ_{L}, φ_{L}). The expression “vicinity” implies that a deviation from (θ_{L}, −φ_{L}) or (θ_{L}, φ_{L}) is preferably within 5°, more preferably within 3°, and even more preferably within 2°. On such a condition, when the functional laminate 10 is affixed to the external support 6 with the direction of OQ directing upward, the incident light L₁ incoming from the sky can be efficiently returned, even with buildings standing side by side at substantially the same height in the surroundings, toward the sky above the other buildings.

To realize the above-described directional reflection, it is preferable, for example, to employ part of a three-dimensional structure, including not only part of a spherical surface or a hyperbolic surface, but also lateral surface of, e.g., a triangular pyramid, a quadrangular pyramid, or a circular cone. The light incoming in the direction (θ_{L}, φ_{L}: −90°<φ_{L}<90°) can be reflected in the direction (θ_{R}, φ_{R}: 0°<θ_{R}<90° and −90°<φ_{R}<90°) in accordance with the shape of the three-dimensional structure. Alternatively, the three-dimensional structure is preferably formed as a columnar body extending in one direction. The light incoming in the direction (θ_{L}, φ_{L}: −90°<φ_{L}<90°) can be reflected in the direction (θ_{R}, φ_{R}: 0°<θ_{R}<90° and φ_{R}=−φ_{L}) in accordance with the slope angle of the columnar body.

A value of the above-mentioned transmission image clarity is preferably 50 or larger, more preferably 60 or larger, and even more preferably 75 or larger when an optical comb of 0.5 mm is used. If the value of the transmission image clarity is smaller than 50, a transmission image tends to blur in appearance. When the value of the transmission image clarity is not smaller than 50 and smaller than 60, there are no problems in daily life though depending on outdoor brightness. When the value of the transmission image clarity is not smaller than 60 and smaller than 75, the outdoor sight can be clearly viewed although only a very bright object, such as a light source, causes a displeasing diffraction pattern. When the value of the transmission image clarity is not smaller than 75, the diffraction pattern is hardly displeasing. Further, a total of values of the transmission image clarity measured by using optical combs of 0.125 mm, 0.5 mm, 1.0 mm and 2.0 mm is preferably 230 or larger, more preferably 270 or larger, and even more preferably 350 or larger. If the total value of the transmission image clarity is smaller than 230, a transmission image tends to blur in appearance. When the total value of the transmission image clarity is not smaller than 230 and smaller than 270, there are no problems in daily life though depending on outdoor brightness. When the total value of the transmission image clarity is not smaller than 270 and smaller than 350, the outdoor sight can be clearly viewed although only a very bright object, such as a light source, causes a displeasing diffraction pattern. When the total value of the transmission image clarity is not smaller than 350, the diffraction pattern is hardly displeasing. Herein, the value of the transmission image clarity is measured in conformity with JIS K7105 by using ICM-IT made by Suga Test Instruments Co., Ltd. When the wavelength to be transmitted differs from that of the D65 light source, the measurement is preferably performed after calibration by using a filter having the wavelength to be transmitted.

Haze occurred in the transmission wavelength band is preferably 6% or less, more preferably 4% or less, and even more preferably 2% or less. The reason is that if the haze exceeds 6%, the transmitted light is scattered and a view is obscured. Herein, the haze is measured in accordance with the measurement method stipulated in JIS K7136 by using HM-150 made by Murakami Color Research Laboratory Co., Ltd. When the wavelength to be transmitted differs from that of the D65 light source, the measurement is preferably performed after calibration using a filter having the wavelength to be transmitted. The incident surface S1, preferably both of the incident surface S1 and an emergent surface S2, of the functional laminate 10 have smoothness at such a level as not degrading the transmission image clarity. More specifically, arithmetic mean roughness Ra of the incident surface S1 and the emergent surface S2 is preferably 0.08 μm or less, more preferably 0.06 μm or less, and even more preferably 0.04 μm or less. Note that the arithmetic mean roughness Ra is obtained as a roughness parameter by measuring the surface roughness of the incident surface S1 and deriving a roughness curve from a two-dimensional profile curve. Measurement conditions are in conformity with JIS B0601:2001. Details of a measurement apparatus and the measurement conditions are as follows:

Measurement apparatus: full-automated fine shape measuring machine SURFCODER ET4000A (made by Kosaka Laboratory Ltd.)

λc: 0.8 mm,

Evaluation length: 4 mm

Cutoff: ×5

Data sampling interval: 0.5 μm

The light transmitted through the functional laminate 10 is preferably as close as possible to neutral in color. Even when the transmitted light is colored, the color preferably has a light tone in blue, blue-green, or green, for example, which provides a cool feeling. From the viewpoint of obtaining such a color tone, chromaticity coordinates x and y of the transmitted light, output from the emergent surface S2 after entering the incident surface S1 and passing through the resin layers and the functional layer 1, satisfy respective ranges of preferably 0.20<x<0.35 and 0.20<y<0.40, more preferably 0.25<x<0.32 and 0.25<y<0.37, and even more preferably 0.30<x<0.32 and 0.30<y<0.35, when measured for irradiation using the D65 light source, for example. Further, from the viewpoint of avoiding the color tone from becoming reddish, the chromaticity coordinates x and y satisfy the relationship of preferably y>x−0.02 and more preferably y>x.

In addition, change of the reflected color tone depending on the incident angle is undesired because, when the functional laminate is applied to, e.g., building windows, the color tone is different depending on a viewing place and an appearing color is changed upon walking From the viewpoint of suppressing the above-mentioned changes in the color tone of the reflected light, the light preferably enters the incident surface S1 or the emergent surface S2 at the incident angle θ of 0° or larger and 60° or smaller, and each of an absolute value of difference between chromaticity coordinates x and an absolute value of difference between chromaticity coordinates y of the lights reflected by the resin layer and the functional layer 1 is preferably 0.05 or smaller, more preferably 0.03 or smaller, and even more preferably 0.01 or smaller at each of both the principal surfaces of the functional laminate 10. The above-described limitations on numerical ranges regarding the chromaticity coordinates x and y of the reflected light are desirably satisfied for the principal surfaces of both the incident surface S1 and the emergent surface S2.

Examples of the functional laminate serving as the optical functional laminate will be described below as modifications of the first embodiment.

<First Modification>

FIG. 8 is a sectional view illustrating the structure of a functional laminate 50 according to a first modification. The functional laminate 50 differs from the functional laminate 10 in that the former includes a self-cleaning effective layer 51, which develops a self-cleaning effect, on the incident surface. The self-cleaning effective layer 51 contains a photocatalyst, such as titanium oxide TiO₂, and can uniformly wash out dirt and dust, which have adhered onto the surface of the self-cleaning effective layer 51, with rainwater by utilizing the hydrophilic property of the photocatalyst. Additionally, a water-repellent layer (e.g., a layer of a fluorine- or silicone-based resin having water repellency) may be formed instead of the self-cleaning effective layer 51.

The light incident surface of the functional laminate, which is constituted as an optical element, is preferably kept optically transparent at all times. However, when the functional laminate is installed outdoor or in a dirty room, contaminants may adhere onto the surface of the functional laminate and scatter light, thus degrading the optical characteristic thereof With the first modification, since the self-cleaning effective layer 51 (hydrophilic layer) or the water-repellent layer is provided, it is possible to suppress adhering of contaminants, etc. onto the surface of the functional laminate and to prevent degradation of the optical characteristics thereof.

<Second Modification>

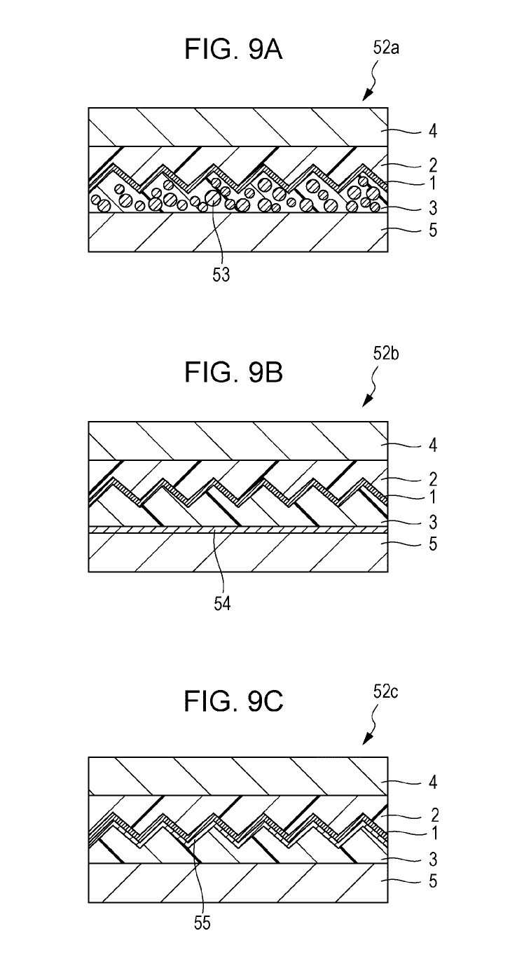

FIGS. 9A to 9C are each a sectional view illustrating the structure of a functional laminate 52 according to a second modification. The functional laminate 52 differs from the functional laminate 10 in that the former scatters the light L₂ other than the specific wavelength range instead of transmitting the same. With the second modification, it is possible to directionally reflect the light L₁ in the specific wavelength range, e.g., the infrared light, and to scatter the light L₂ other than the specific wavelength range, e.g., visible light. Such a feature enables the functional laminate 52 to have a visually specific design like a frosted glass.

FIG. 9A is a sectional view illustrating the structure of one example 52a of the functional laminate 52. In the functional laminate 52a, the second resin layer 3 includes fine particles 53 for scattering the light L₂. The fine particles 53 have a refractive index differing from that of the resin that is a main component of the second resin layer 3. The fine particles 53 may be, for example, hollow fine particles. The fine particles 53 are at least one type of inorganic and organic fine particles. Examples of the fine particles 53 include inorganic fine particles, such as silica fine particles and alumina fine particles, and organic fine particles, such as styrene-resin fine particles, (meth)acryl-resin fine particles, and fine particles of a copolymer of the formers. Of those examples, the silica fine particles are particularly preferable.

FIGS. 9B and 9C are sectional views illustrating the structures of other examples 52b and 52c of the functional laminate 52, respectively. In the functional laminate 52b, a light diffusion layer 54 is disposed on the light transmitted side of the second resin layer 3. In the functional laminate 52c, a light diffusion layer 55 is disposed between the functional layer 1 and the second resin layer 3. Each of the light diffusion layers 54 and 55 includes a resin and fine particles that are similar to the fine particles 53.

In the functional laminate 52, a light scatterer, such as the fine particles and the light diffusion layer for scattering the incident light, is desirably positioned on the light transmitted side with respect to the functional layer 1. The reason is that, if the light scatterer is present between the light incident surface and the functional layer 1, the directional reflection characteristic is degraded. When the functional laminate 52 is affixed to a window glass, for example, it may be affixed to either the indoor side or the outdoor side of the adherend.

<Third Modification>

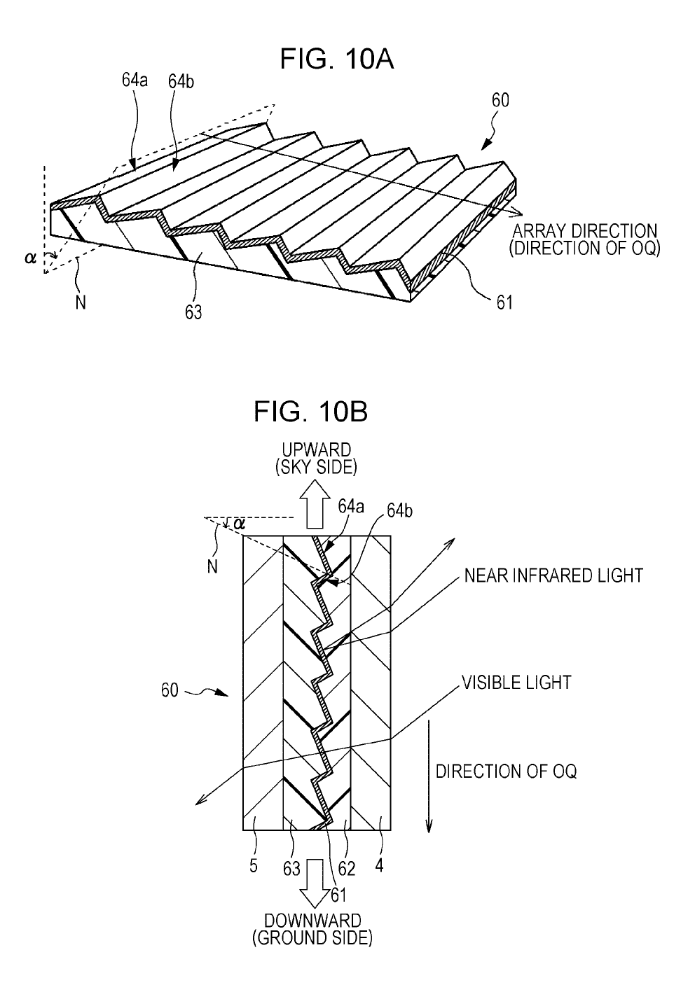

FIG. 10A is a perspective view illustrating the shape of a functional layer 61 according to a third modification, and FIG. 10B is a sectional view illustrating the structure of a functional laminate 60 according to the third modification. For simpler representation and easier understanding, only the functional layer 61 and a second resin layer 63 are illustrated in FIG. 10A. As in the functional layer 1, a reflecting surface of the functional layer 61 is constituted by a reflecting surface group including two types of many reflecting surfaces 64a and 64b each of which has an elongate rectangular shape in a plan view. Those many reflecting surfaces 64a and 64b are alternately arrayed side by side in one direction, i.e., in a one-dimensionally cyclic pattern. Long sides of each of the reflecting surfaces 64a and 64b are formed parallel to a light incident surface (e.g., the surface of the first support 4; see FIG. 10B), while short sides thereof are formed to be inclined at a certain angle with respect to the light incident surface. Unlike the functional layer 1, the reflecting surfaces 64a and 64b of the functional layer 61 differ from each other in not only length of the short side, but also inclination with respect to the light incident surface therebetween. A plane N bisecting an angle formed by the reflecting surfaces 64a and 64b adjacent to each other is inclined by a from the direction perpendicular to the light incident surface. Thus, the reflecting surfaces 64a and 64b are asymmetrical with respect to the bisecting plane N. In other words, the reflecting surfaces of the functional layer 61 do not have inversion symmetry in the one-dimensional array direction. A direction in which retro-reflectance of the functional layer 61 is maximized is present substantially in the bisecting plane N. In the case of the functional layer 61, since the bisecting plane N is not perpendicular to the light incident surface, the direction in which the retro-reflectance is maximized is inclined from the direction perpendicular to the light incident surface.

When the functional laminate is affixed to a member disposed substantially vertically to the ground, such as a window glass, the direct light from the sun does not enter the member from below (i.e., the ground side), and an amount of light incoming from above (i.e., the sky side) is generally much more than an amount of light incoming from below (i.e., the ground side) even when the reflected light and the scattered light are also taken into consideration. Further, optical energy from the sun arrives in a larger amount in a time zone past the noon, and the altitude of the sun is mostly higher than 45° in such a time zone. When a distribution of the incident direction of the incident light is asymmetrical as described above, the near infrared light coming from the sun can be more effectively reflected upward (toward the sky side) by arranging the functional laminate 60, which has the asymmetrical reflecting surface (in the one-dimensional array direction), in an appropriate orientation rather than arranging, e.g., the functional laminate 10, which has the symmetrical reflecting surface (in the one-dimensional array direction). In that case, the orientation of the functional laminate may be optionally selected, as described below, depending on the reflectance of the functional layer 61.

When the reflectance of the functional layer 61 is large, the functional laminate 60 is preferably arranged such that the direction of OQ, i.e., the direction in which the retro-reflectance is maximized, is oriented upward (toward the sky side). With such an arrangement, the incident light incoming from above can be returned upward with the retroreflection function of the functional layer 61.

As described above, FIG. 4B is a sectional view illustrating the function of the functional layer 1. For simpler representation and easier reading, the first resin layer 2 and the second resin layer 3 are illustrated without hatching. The surface of the first support 4 is flat. One surface of the first resin layer 2 on the side oppositely away from the side contacting with the functional layer 1 is also flat. In the functional laminate 10, the flat surface of the first support 4 (or the flat surface of the first resin layer 2 when the first support 4 is omitted) serves as a light incident surface. When the functional layer 1 is made of the material and/or the layer structure selectively reflecting near infrared light, the near infrared light incident on the reflecting surface of the functional layer 1 is usually specularly reflected once for each of the reflecting surfaces 7a and 7b, i.e., twice in total, and then retroreflected toward the light source side. On the other hand, visible light simply passes through the functional layer 1. Because a symmetry plane of the reflecting surfaces 7, i.e., the bisecting plane N, is perpendicular to the optical incident surface in the functional layer 1, retro-reflectance is maximized in the direction perpendicular to the incident surface.

However, because the retroreflection is performed by repeating specular reflection several times, eventual reflectance with the retroreflection is reduced when the reflectance of the functional layer 61 is small. In that case, as illustrated in FIG. 10B, the functional laminate 60 is preferably arranged such that the direction in which the bisecting plane N is inclined is oriented downward (toward the ground side). With such an arrangement, larger part of the light incident on the functional layer 61 from above enters the reflecting surface 64a having a larger area, and is returned upward after being specularly reflected once.

Thus, when the incident direction of the incident light is not constant and is partially distributed, it is often more effective to arrange the functional laminate having the asymmetrical reflecting surfaces, for which a symmetry plane (e.g., the bisecting plane) or a symmetry axis is inclined in one direction, in an appropriate orientation rather than arranging the functional laminate having the reflecting surfaces arrayed with a high degree of symmetry. While the above description is made in connection with an example in which the reflecting surfaces are arrayed in a one-dimensionally cyclic pattern, it is similarly applied to the case where the unit recesses are two-dimensionally arrayed, such as the functional layer 21 having the double V-groove shape illustrated in FIG. 5, and the functional layer 31 having the corner cube shape illustrated in FIG. 6.

In the case of the functional layer 31 having the corner cube shape, for example, when the curvature radius R of a ridgeline is large, the corner cube is preferably inclined toward the sky, and when suppression of downward reflection is demanded, it is preferably inclined toward the ground side. Because the sunlight obliquely enters the functional laminate 30, the light is hard to come into deep portions of the laminate structure, and hence the shape of the laminate structure on the incident side is important. More specifically, when the curvature radius of the ridgeline is large, the retroreflected light is reduced, but such a disadvantageous phenomenon can be suppressed by arranging the corner cube to be inclined toward the sky. Further, in the functional layer 31 having the corner cube shape, the retroreflection is usually performed by repeating reflection three times at the reflecting surfaces, but part of the light may be often leaked to other directions than the retroreflection direction after repeating the reflection twice. Most of the leaked light can be returned toward the sky by orienting the corner cube to be inclined toward the ground side. Thus, the functional laminate can be arranged such that the symmetry plane or axis is inclined in an appropriate direction depending on the shape and the usage thereof.

<Fourth Modification>

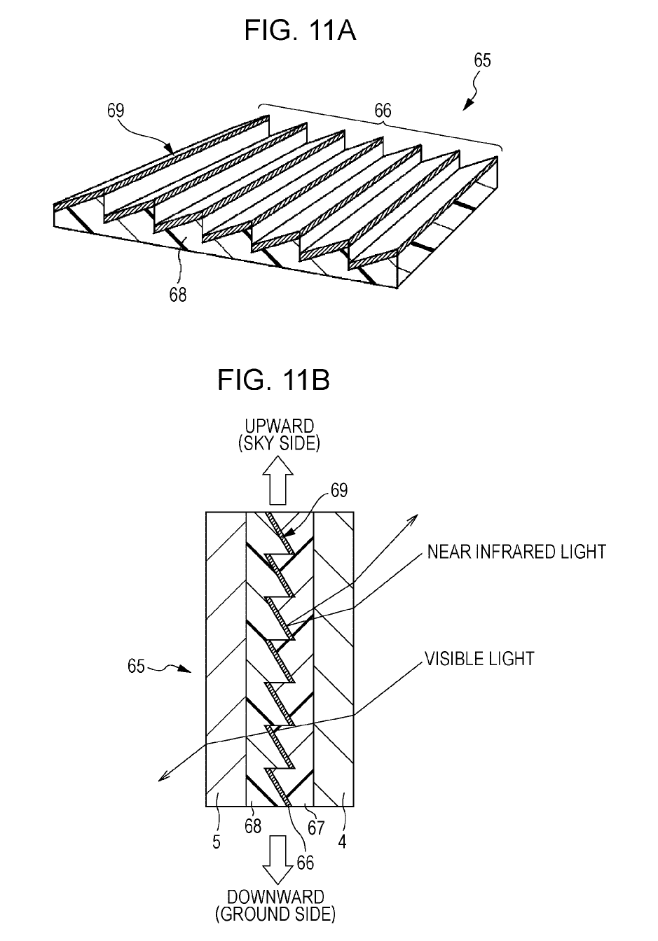

FIG. 11A is a perspective view illustrating the shape of a functional layer 66 according to a fourth modification, and FIG. 11B is a sectional view illustrating the structure of a functional laminate 65 according to the fourth modification. For simpler representation and easier understanding, only the functional layer 66 and a second resin layer 68 are illustrated in FIG. 11A. As in the functional layer 1, a reflecting surface of the functional layer 66 is constituted by a reflecting surface group including one type of many reflecting surfaces 69 each of which has an elongate rectangular shape in a plan view. Those many reflecting surfaces 69 are arrayed in one direction, i.e., in a one-dimensionally cyclic pattern. Long sides of each of the reflecting surfaces 69 are formed parallel to a light incident surface (e.g., the surface of the first support 4; see FIG. 11B), while short sides thereof are formed to be inclined at a certain angle with respect to the light incident surface.

It can be thought that the reflecting surfaces of the functional layer 66 are obtained by omitting the reflecting surfaces 64b from the reflecting surfaces of the functional layer 61, while leaving only the reflecting surfaces 64a to serve as the reflecting surfaces 69. Because the reflecting surfaces 64b are omitted, the reflecting surfaces of the functional layer 66 do not have the function of directional reflection. With the omission of the reflecting surfaces 64b, therefore, light incident on the functional layer 66 from above can be all returned upward after one specular reflection by the reflecting surfaces 69 that are oriented upward.

As described above, because the retroreflection is performed by repeating specular reflection several times, eventual reflectance with the retroreflection is reduced when the reflectance of the functional layer is small. Therefore, when most part of the incident light enters the functional layer from above, it is more advantageous to return the light incoming from above upward after one specular reflection by the reflecting surfaces 69 that are oriented upward. The functional laminate 66 according to the fourth modification represents an example of the optical functional layer that is specialized to be adapted for such a demand.

<Fifth Modification>

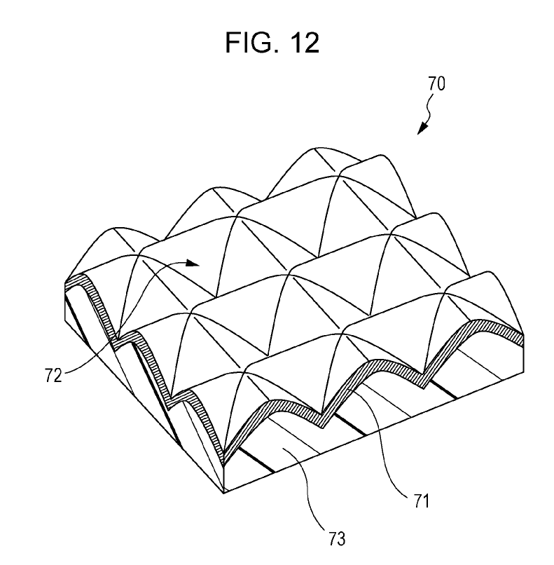

FIG. 12 is a perspective view illustrating the shape of a functional layer 71 according to a fifth modification. For simpler representation and easier understanding, only the functional layer 71 and a second resin layer 73 of a functional laminate 70 are illustrated in FIG. 12. The functional layer 71 is a modification of the functional layer 21 illustrated in FIG. 5. As in the reflecting surface of the functional layer 21, a reflecting surface of the functional layer 71 is made up of many unit recesses 72 that are regularly arrayed. However, the reflecting surface of the functional layer 71 differs from the reflecting surface of the functional layer 21 in that a top portion of the reflecting surface has a rounded shape (i.e., a shape having a curvature radius R).

<Sixth Modification>

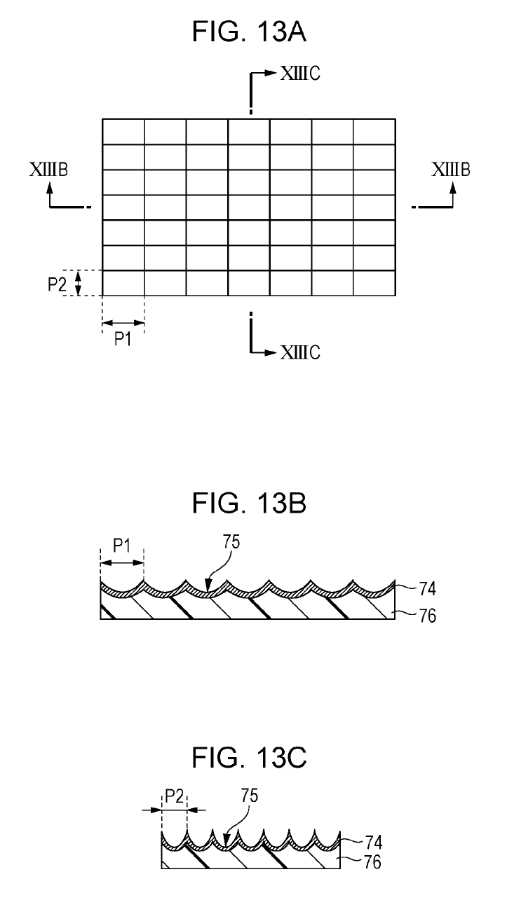

FIG. 13A is a plan view illustrating a two-dimensional array in a functional layer 74 according to a sixth modification, and FIGS. 13B and 13C are sectional views taken along lines XIIIB-XIIIB and XIIIC-XIIIC in the plan view of FIG. 13A, respectively. As in the functional layer 21 illustrated in FIG. 5 and the functional layer 31 illustrated in FIG. 6, a reflecting surface of the functional layer 74 is made up of many unit recesses 75 that are regularly densely arrayed. Each of the unit recesses 75 has an outer periphery that is rectangular in a plan view, and a recess having a reflecting surface defined by a smooth curved surface is formed inside the rectangular periphery. The functional layer 74 also functions as a retroreflection layer similarly to the functional layer 21 and the functional layer 31.

<Seventh Modification>

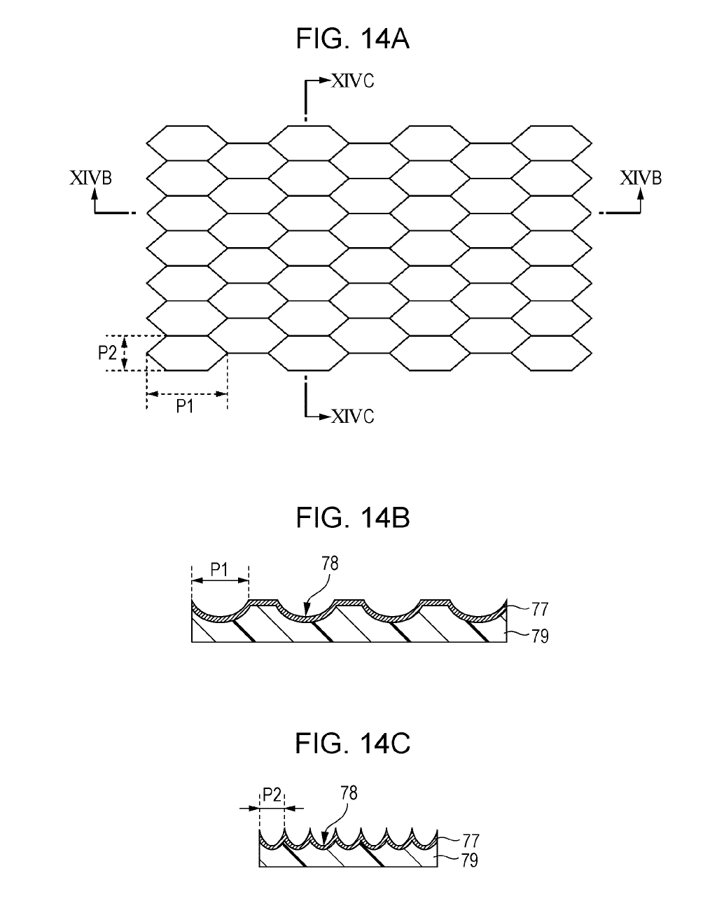

FIG. 14A is a plan view illustrating a two-dimensional array in a functional layer 77 according to a seventh modification, and FIGS. 14B and 14C are sectional views taken along lines XIVB-XIVB and XIVC-XIVC in the plan view of FIG. 14A, respectively. As in the functional layer 74 illustrated in FIGS. 13A to 13C, a reflecting surface of the functional layer 77 is made up of many unit recesses 78 that are regularly densely arrayed. Each of the unit recesses 78 has an outer periphery that is hexagonal in a plan view, and a recess having a reflecting surface defined by a smooth curved surface is formed inside the hexagonal periphery. The functional layer 77 also functions as a retroreflection layer similarly to the functional layer 74.

### Second Embodiment

A second embodiment will be described below in connection with examples of a functional structure. The functional laminate according to the embodiment can be typically affixed to, e.g., a glass, thereby constituting a functional structure, such as a window member. Further, the functional laminate according to the embodiment can be utilized so as to constitute functional structures in the form of, e.g., various interior and exterior members. Those functional structures include not only fixedly installed members such as walls and roofs, but also a member capable of changing an extent at which the optical functional laminate develops the function in its application, as appropriate, depending on changes of the seasons and time, etc. One practical example of the latter member is a window blind (shade), which is constituted by dividing the optical functional laminate into plural elements and assembling the plural elements such that the amount by which incident light is transmitted through the optical functional laminate can be adjusted, for example, by changing an angle of the optical functional laminate. Another example is a rolling curtain utilizing the optical functional laminate that can be wound or folded. Still another example is a shoji (i.e., a paper-made and/or glass-fitted sliding door) constituted by fixing a optical functional body (including the functional laminate) to, e.g., a frame such that the frame can be removed, as appropriate, including the optical functional body.

The interior and exterior members utilizing the optical functional laminate can be practiced, for example, by using the functional laminate itself, or by affixing the functional laminate to a transparent base element. By installing such an interior or exterior member indoor near a window, it is possible, for example, to directionally reflect only infrared light to the outdoor, and to take visible light into the door. Accordingly, the necessity of indoor illumination can be reduced even when the interior or exterior member is installed. Further, since the interior or exterior member hardly causes scattering reflection toward the indoor, a temperature rise in the surroundings can be suppressed. In addition, the functional laminate can be affixed to other elements than the transparent base element depending on demands, such as visibility control and improvement of the strength.

### FIRST APPLICATION EXAMPLE

A first application example is described in connection with the case of applying the functional laminate to a window blind (shade), i.e., one example of a solar shading device capable of adjusting an extent at which the incident light is to be blocked, by changing an angle of a solar shading member group that includes a plurality of solar shading members.

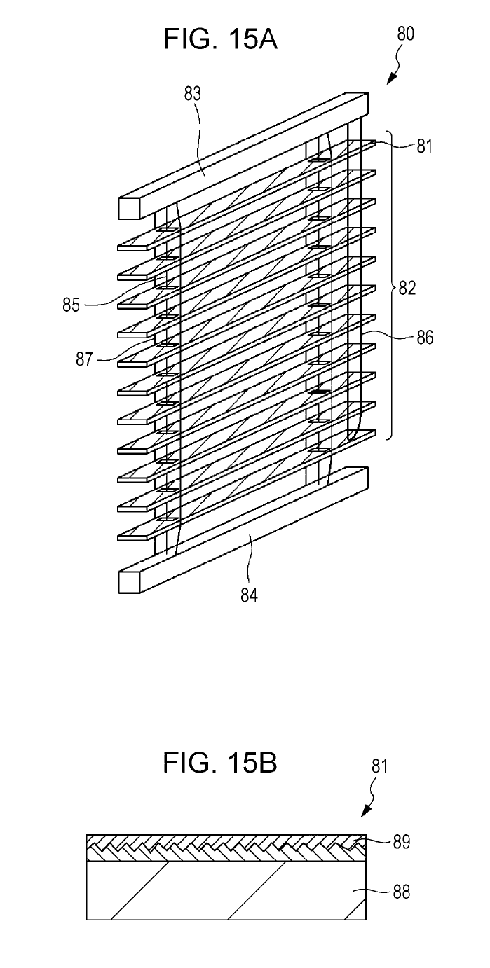

FIG. 15A is a perspective view illustrating the structure of a window blind (shade) 80 as one example of the solar shading device. The window blind 80 includes a head box 83, a slat group (solar shading member group) 82 made up of plural slats (blades) 81, and a bottom rail 84. The head box 83 is disposed above the slat group 82. Rise-and-fall chords 85 and a rise-and-fall operating chord 86 are extended downward from the head box 83, and the bottom rail 84 is suspended at lower ends of the chords 85. The slats 81 serving as the solar shading members are each formed in a slender rectangular shape and are supported by ladder chords 87, which are extended downward from the head box 83, at predetermined intervals in a suspended state.

The head box 83 includes an operating member (not shown), such as a rod, for adjusting an inclination angle of the slat group 82. The head box 83 serves to change the inclination angle of the slat group 82 in accordance with operation of the operating member, such as the rod, thereby adjusting the amount of light taken into the indoor, for example. The head box 83 also serves as a driving unit (raising and lowering unit) for raising and lowering the slat group 82 in accordance with an operating member, e.g., the rise-and-fall operating chord 86.

FIG. 15B is a sectional view illustrating an example of construction of the slat (blade) 81. The slat 81 includes a base element 88 and a functional laminate 89. The functional laminate 89 is preferably disposed on one of two principal surfaces of the base element 88, the one principal surface being positioned on the side including an incident surface on which outside light is incident when the slat group 82 is in a closed state (e.g., on the side facing a window member). The functional laminate 89 and the base element 88 are affixed to each other with, for example, a bonding layer interposed between them.

The base element 88 can be formed in the shape of, e.g., a sheet, a film, or a plate. The base element 88 can be made of, e.g., glass, resin, paper, or cloth. In consideration of the case of taking visible light into a predetermined indoor space, for example, a resin having transparency is preferably used as the material of the base element 88. As the glass, the resin, the paper, or the cloth, the same materials as those generally used in ordinary rolling screens can be used. One type or two or more types of the above-described functional laminates according to the above-described embodiments can be used alone or in combination as the functional laminate 89.

As another example of construction of the slat (blade) 81, the functional laminate 89 may be used itself as the slat 81. In that case, the functional laminate 89 preferably has such a level of rigidity that the functional laminate 89 can be supported by the ladder chords 87 and can maintain its shape in a supported state.

While the first application example has been described above in connection with the case of applying the functional laminate 89 to a horizontal-type window blind (Venetian blind), the functional laminate may be applied to a vertical-type window blind as well.

### SECOND APPLICATION EXAMPLE

A second application example is described in connection with a rolling screen device, i.e., another example of the solar shading device capable of adjusting an extent at which the incident light is to be blocked, by winding or unwinding a solar shading member.

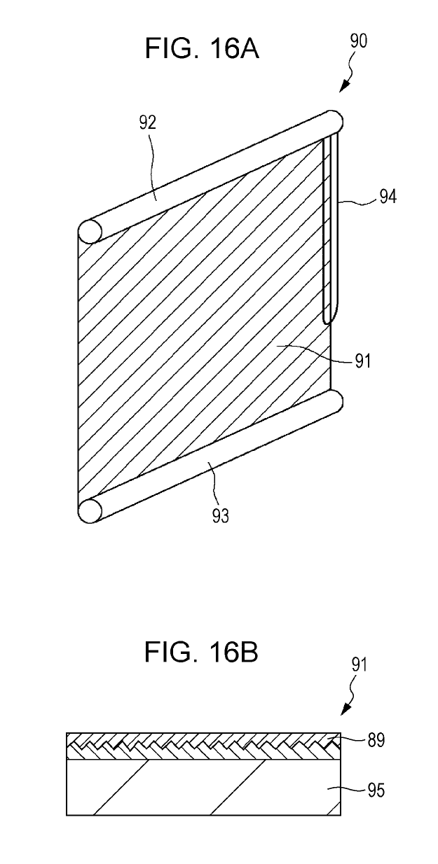

FIG. 16A is a perspective view illustrating the structure of a rolling screen device 90 as another example of the solar shading device. The rolling screen device 90 includes a head box 91, a screen 92, and a core member 93. The head box 91 can raise and fall the screen 92 with operation of an operating member that is in the form of a chain 94, for example. The head box 91 includes therein a winding shaft for taking up and letting out the screen 92, and one end of the screen 92 is coupled to the winding shaft. Further, the core member 93 is coupled to the other end of the screen 92. Preferably, the screen 92 has flexibility. The shape of the screen 92 is not limited to particular one and is preferably selected depending on the shape of, e.g., a window member to which the rolling screen device 90 is applied. For example, the screen 92 has a rectangular shape.

FIG. 16B is a sectional view illustrating an example of construction of the screen 92. The screen 92 includes a base element 95 and a functional laminate 89, and it preferably has flexibility. The functional laminate 89 is preferably disposed on one of two principal surfaces of the base element 95, the one principal surface being positioned on the side including an incident surface on which outside light is incident (e.g., on the side facing the window member). The functional laminate 89 and the base element 95 are affixed to each other with, for example, a bonding layer interposed between them. Note that the construction of the screen 92 is not limited to the illustrated example and the functional laminate 89 may be used itself as the screen 92.

The base element 95 can be formed in the shape of, e.g., a sheet, a film, or a plate. The base element 95 can be made of, e.g., glass, resin, paper, or cloth. In consideration of the case of taking visible light into a predetermined indoor space, for example, a resin having transparency is preferably used as the material of the base element 95. As the glass, the resin, the paper, or the cloth, the same materials as those generally used in ordinary rolling screens can be used. One type or two or more types of the above-described functional laminates according to the embodiments can be used alone or in combination as the functional laminate 89.

While the second application example has been described above in connection with the rolling screen device, application examples are not limited to the illustrated one. For example, embodiments are applicable to a solar shading device where an extent at which a solar shading member blocks the incident light can be adjusted by folding or unfolding the solar shading member. One example of such a solar shading device is a pleated screen device where an extent at which the solar shading member blocks the incident light can be adjusted by folding or unfolding a screen as the solar shading member in the form of bellows.

### THIRD APPLICATION EXAMPLE

A third application example is described in connection with the case of applying the functional laminate to a fitting (e.g., an interior or exterior member) that includes a lighting portion provided with an optical functional body having the directional reflection function.

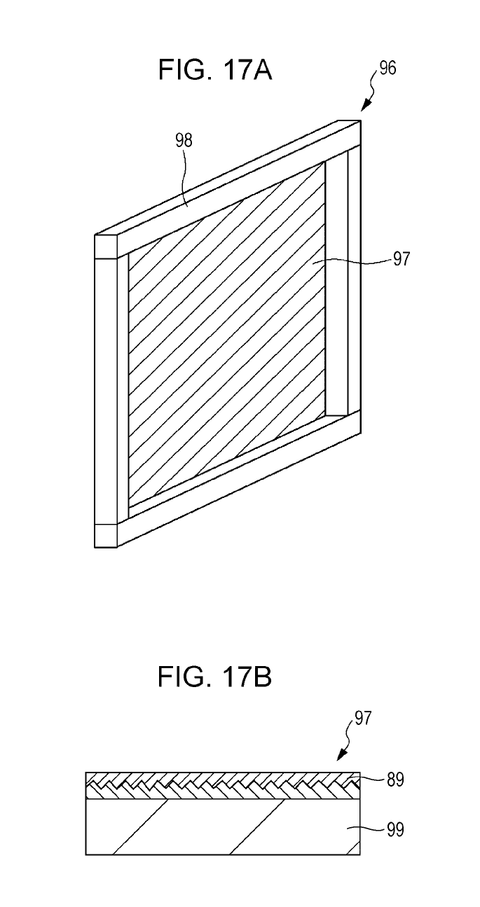

FIG. 17A is a perspective view illustrating the construction of a fitting 96 as the solar shading member. The fitting 96 includes a lighting portion provided with an optical functional body 97, and a peripheral portion in the form of a frame member 98 that serves as a support. One example of the fitting 96 is a shoji (i.e., a paper-made and/or glass-fitted sliding door), but applications are not limited to such an example. Embodiments can be applied to various types of fittings that include lighting portions. While the optical functional body 97 is fixedly held by the frame member 98, the optical functional body 97 may be removable, if necessary, by disassembling the frame member 98.

FIG. 17B is a sectional view illustrating one example of construction of the optical functional body 97. The optical functional body 97 includes a base element 99 and a functional laminate 89. The functional laminate 89 is preferably disposed on one of two principal surfaces of the base element 99, the one principal surface being positioned on the side including an incident surface on which outside light is incident (e.g., on the side facing outward). The functional laminate 89 and the base element 99 are affixed to each other with, for example, a bonding layer interposed between them. Note that the construction of the optical functional body 97 is not limited to the illustrated example and the functional laminate 89 may be used itself as the optical functional body 97.

The base element 99 can be formed of, e.g., a sheet, a film, or a plate each having flexibility. The base element 99 can be made of, e.g., glass, resin, paper, or cloth. In consideration of the case of taking visible light into a predetermined indoor space, for example, a resin having transparency is preferably used as the material of the base element 99. As the glass, the resin, the paper, or the cloth, the same materials as those generally used in optical functional bodies in ordinary fittings can be used. One type or two or more types of the above-described functional laminates according to the embodiments and the modifications can be used alone or in combination as the functional laminate 89.

While the foregoing application examples have been described in connection with the cases of applying the functional laminate to the window member, the slat of the window blind, the screen of the rolling screen device, and the fitting as examples of the interior or exterior member, application examples are not limited to the illustrated ones. The functional laminate can be further applied to the other interior and exterior members than the above-described one.

### EXAMPLES

The present invention will be described in more detail below in connection with EXAMPLES. Be it noted that the following EXAMPLES are to be construed as not limiting the scope.

### Examples 1 to 6

In EXAMPLES 1 to 6, an optical functional film selectively and directionally reflecting the near infrared light, but transmitting visible light therethrough was fabricated as a practical example of the functional laminate 10 illustrated in FIG. 1A. In the fabrication, the pitch was set to 50 μm, the first resin layer and the second resin layer were made of the same material, and the first support and the second support were made of the same material. Various materials having different elastic moduli were used as resin and support materials to study influences of the various materials.

<Fabrication of Optical Functional Film>

First, as illustrated in FIG. 2A, the same three-dimensional shape as that of the functional layer 1 was formed on the surface of the die 41 made of nickel-phosphorous (Ni—P) by cutting with a bite.

Next, as illustrated in FIG. 2B, the first resin material layer 42 was formed on the surface of the die 41 by an application method. Further, the first support 4 in the form of a film having a thickness of 100 μm was pressed onto the first resin material layer 42 such that the die 41, the first resin material layer 42, and the first support 4 were brought into a closely contacted state.

Next, as illustrated in FIG. 2C, the first resin material layer 42 was irradiated with ultraviolet light from the side including the first support 4 to cure the resin monomer and/or oligomer, thereby forming the first resin layer 2.

Next, a laminate of the first support 4 and the first resin layer 2 was peeled off from the die 41 to obtain the first resin layer 2 to which the three-dimensional shape of the surface of the die 41 was reversely transferred.

Next, as illustrated in FIG. 3A, an alternating multilayer film made up of a niobium(V)-oxide Nb₂O₅ layer and a silver Ag layer was formed as the functional layer 1 on the surface of the first resin layer 2, onto which the three-dimensional shape had been transferred, by sputtering.

Next, as illustrated in FIG. 3B, the second resin material layer 43 was formed on the other principal surface of the functional layer 1 by an application method. After pushing out bubbles from the second resin material layer 43, the second support 5 in the form of a film having a thickness of 100 μm was pressed onto the second resin material layer 43 such that the functional layer 1, the second resin material layer 43, and the second support 5 were brought into a closely contacted state.

Next, as illustrated in FIG. 3C, the second resin material layer 43 was irradiated with ultraviolet light from the side including the second support 5 to cure the resin monomer and/or oligomer, thereby forming the second resin layer 3. As a result, the optical functional film was obtained as a practical example of the intended functional laminate 10.

Table 1 lists the resin and support materials used in EXAMPLES 1 to 6 and COMPARATIVE EXAMPLES 1 to 3. Compositions of resin materials A to H are as follows.

Resin Material A

| | |
|---|---|
| polyvinyl butyral | 70% by mass |
| (mean molecular weight = 90000 to 120000) | |
| triethylene glycol bis(2-ethylhexanoic acid) | 30% by mass |

Resin Material B

| | |
|---|---|
| urethane acrylate (CN991) | 48.5% by mass |
| benzyl methacrylate (Light-Ester BZ) | 8.5% by mass |
| photopolymerization initiator (IRGACURE 184) | 3% by mass |

Resin Material C

| | |
|---|---|
| urethane acrylate (UF-8001G) | 48.5% by mass |
| benzyl methacrylate (Light-Ester BZ) | 48.5% by mass |
| photopolymerization initiator (IRGACURE 184) | 3% by mass |

Resin Material D

| | |
|---|---|
| urethane acrylate (UF-8001G) | 41% by mass |
| benzyl methacrylate (Light-Ester BZ) | 41% by mass |
| cross-linking agent (T2325) | 15% by mass |
| photopolymerization initiator (IRGACURE 184) | 3% by mass |

Resin Material E

| | |
|---|---|
| urethane acrylate (ARONIX) | 97% by mass |
| photopolymerization initiator (IRGACURE 184) | 3% by mass |

Resin Material F

| | |
|---|---|
| cyclic polyolefin resin | 100% by mass |

Resin Material G

| | |
|---|---|
| urethane acrylate (ARONIX) | 82% by mass |
| cross-linking agent (T2325) | 15% by mass |
| photopolymerization initiator (IRGACURE 184) | 3% by mass |

Resin Material H

| | |
|---|---|
| PET film (COSMOSHINE A4300) | 100% by mass |

Herein, polyvinyl butyral is made by Sigma-Aldrich Corporation, CN991 (trademark) is made by Sartomer Company, Inc., Light-Ester BZ (trademark) is made by KYOEISHA CHEMICAL Co., LTD., IRUGACURE 184 (trademark) is made by Nippon Kayaku Co., Ltd., UF-8001G (trademark) is made by KYOEISHA CHEMICAL Co., LTD., T2325 (trademark) is made by Tokyo Kasei Kogyo Co., Ltd., ARONIX (trademark) is made by TOAGOSEI CO., LTD., and COSMOSHINE A4300 (trademark) is made by Toyobo Co., Ltd.

TABLE 1

| | First and second | | First and second | | Change | |
|---|---|---|---|---|---|---|
| | resin layers | | supports | | of trans- | |
| | Resin | | Resin | Storage | mit- | Evalu- |
| | mate- | Elastic | mate- | elastic | tance | ation |
| | rial | modulus | rial | modulus | (%) | result |
| EXAMPLE 1 | E | 1.4 × 10⁹ | H | 3.9 × 10⁹ | −1.3 | ∘ |
| EXAMPLE 2 | C | 6.5 × 10⁸ | D | 7.0 × 10⁸ | −1.7 | ∘ |
| EXAMPLE 3 | A | 7.9 × 10⁶ | Glass | 7.2 × 10⁹ | −1.0 | ∘ |
| EXAMPLE 4 | F | 2.1 × 10⁹ | Glass | 7.2 × 10⁹ | −0.5 | ∘ |
| EXAMPLE 5 | E | 1.4 × 10⁹ | G | 2.1 × 10⁹ | −0.7 | ∘ |
| EXAMPLE 6 | D | 7.0 × 10⁸ | D | 7.0 × 10⁸ | −1.8 | ∘ |
| COMPAR- | E | 1.4 × 10⁹ | B | 3.6 × 10⁹ | −2.9 | x |
| ATIVE | | | | | | |
| EXAMPLE 1 | | | | | | |
| COMPAR- | D | 7.0 × 10⁸ | B | 3.6 × 10⁹ | −2.3 | x |
| ATIVE | | | | | | |
| EXAMPLE 2 | | | | | | |
| COMPAR- | D | 7.0 × 10⁸ | C | 6.5 × 10⁸ | −2.1 | x |
| ATIVE | | | | | | |
| EXAMPLE 3 | | | | | | |

<Evaluation Method and Determination Criteria>

Regarding damage occurred at the interface, visible transmittance was measured before and after heat cycles. A heat cycle test was conducted by using TSA-301L-W made by ESPEC CORP. As test conditions, a step of holding a test piece at −40° C. for 1 hour and then holding it at 85° C. for 1 hour was set to one cycle and, after repeating the cycle 100 times, the test piece was taken out at room temperature. Because of the transmittance being reduced with film damage, a degree of the film damage was indirectly evaluated by measuring the transmittance.

<Measurement of Elastic Modulus in Conformity with JIS 7161>

A film-like resin having a thickness of 0.1 mm and punched out into the shape of a dumbbell was measured on the elastic modulus five times for each of different strains at a pulling rate of 5 mm/minute. The elastic modulus at 25° C. was determined from tensile stresses measured for each of strain of 0.0005% and strain of 0.0025%. In the case of glass, a glass piece having a thickness of 100 μm was cut out by using a glass cutter.

<Measurement of Visible Transmittance>

The transmittance at a wavelength 550 nm was measured by using V-7100 (made by JASCO Corporation). As a result of comparing the transmittances between before and after a high-temperature and high-humidity test, a reduction rate of the transmittance at 550 nm was regarded unacceptable when it was 2% or larger, and acceptable when it was smaller than 2%.

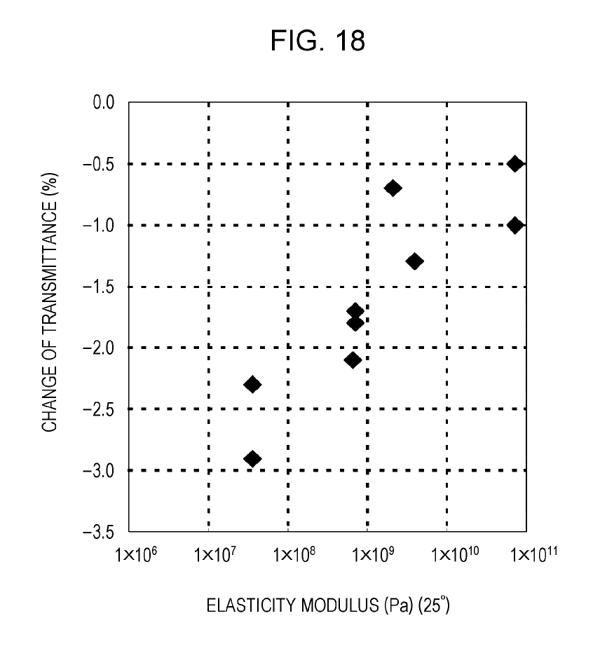

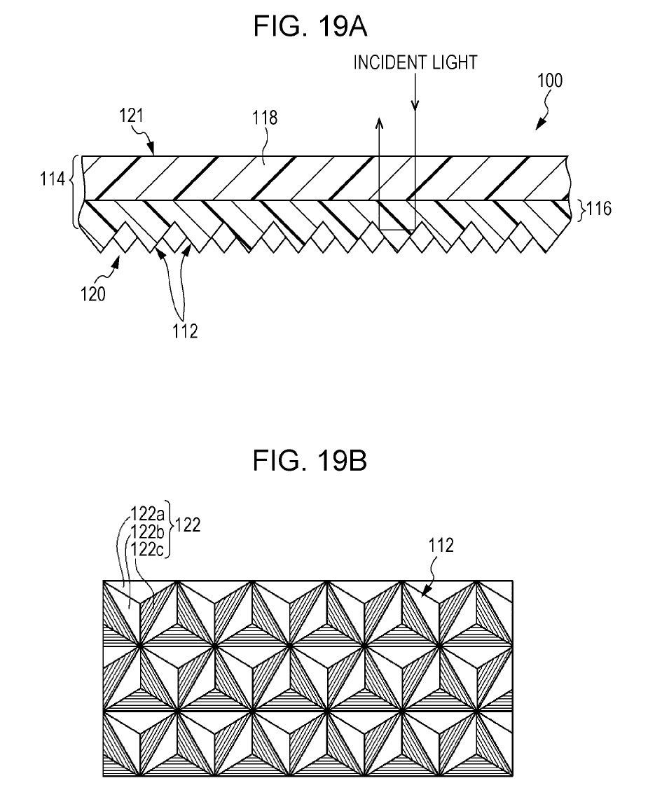

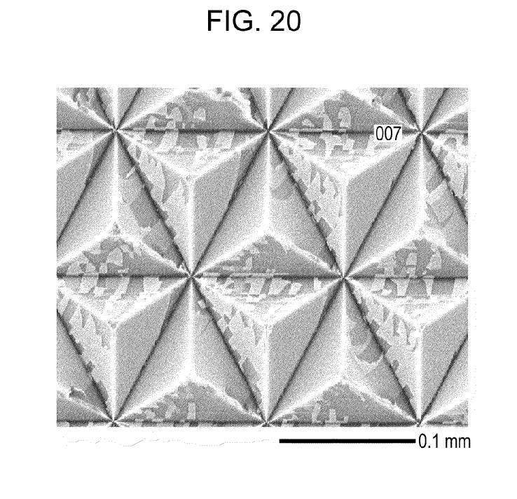

FIG. 18 plots the reduction rates of the transmittance measured for EXAMPLES 1 to 6 and COMPARATIVE EXAMPLES 1 to 3. Further, Table 1 lists values of the reduction rates of the transmittance and evaluation results.

### Example 7

In EXAMPLE 7, an optical functional film selectively and directionally reflecting the near infrared light, but transmitting visible light therethrough was fabricated as a practical example of the functional laminate 11 illustrated in FIG. 1B. In the fabrication, the pitch was set to 50 μm. A functional laminate was fabricated in a similar manner to that in EXAMPLES 1 to 6 by using, as the second support, a quartz plate on which releasing treatment was performed by using, as a release agent, RIRIEISU made by Dow Corning Toray Co., Ltd. The optical functional film was then obtained as a practical example of the functional laminate 11 by removing the quartz plate. Materials used for the first support and the first and second resin layers were as follows:

First support: PET resin COSMOSHINE A4300 (trademark; made by Toyobo Co., Ltd.), elastic modulus of 3.9×10⁹ Pa

First and second resin layers: resin E, elastic modulus of 1.4×10⁹ Pa

The reduction rate of the visible transmittance measured in a similar manner to that in EXAMPLES 1 to 6 was −1.3%. Thus, the evaluation result was acceptable.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A functional laminate comprising:
a functional layer including an inorganic layer formed in a predetermined three-dimensional shape;
a first resin layer and a second resin layer disposed in close contact with two principal surfaces of the functional layer, respectively, and sandwiching the functional layer therebetween; and
a first support and a second support disposed respectively in contact with one surface of the first resin layer on a side oppositely away from the other surface thereof, which is in contact with the functional layer, and with one surface of the second resin layer on a side oppositely away from the other surface thereof, which is in contact with the functional layer, the first support and the second support having elastic moduli larger than elastic moduli of the first resin layer and the second resin layer,
one of the first support and the second support being omissible when the one support is replaced with an external support having an elastic modulus equal to or larger than the elastic modulus of the one support.

2. The functional laminate according to claim 1, wherein the first support or the second support is omitted, and the first resin layer or the second resin layer is affixed to the external support having the elastic modulus larger than the elastic moduli of the first resin layer and the second resin layer.

3. The functional laminate according to claim 1, wherein the elastic moduli of the first support and the second support measured in conformity with JIS 7161 are in a range of 7×10⁸ to 7.2×10¹⁰ Pa at 25° C.

4. The functional laminate according to claim 1, wherein the first resin layer and the second resin layer are made of a same material.

5. The functional laminate according to claim 1, wherein the functional laminate is an optical functional laminate having a light incident surface provided by a surface of the first support and reflecting, absorbing, semi-transmitting, or transmitting incident light.

6. The functional laminate according to claim 5, wherein the functional layer is an optical functional layer having a directional reflection property.

7. The functional laminate according to claim 6, wherein a reflecting surface of the functional layer is made up of reflecting surface groups including a group of many first reflecting surfaces and a group of many second reflecting surfaces,
the first reflecting surfaces and the second reflecting surfaces are each formed in an elongate rectangular shape in a plan view such that long sides of the first and second reflecting surfaces are equal to each other and are parallel to the light incident surface, while short sides of the first and second reflecting surfaces are inclined at a certain angle with respect to the light incident surface, and
the many first reflecting surfaces and the many second reflecting surfaces are alternately arrayed in a one-dimensionally cyclic pattern in a direction perpendicular to a lengthwise direction of the reflecting surfaces.

8. The functional laminate according to claim 6, wherein the reflecting surface of the functional layer is made up of many unit recesses or unit projections that are regularly arrayed, and a three-dimensional shape of the unit recesses or unit projections is pyramidal, conical, semi-spherical, or cylindrical.

9. The functional laminate according to claim 6, wherein an surface direction of a symmetrical plane or a direction of a symmetrical axis of the reflecting surface of the functional layer, the direction providing a direction in which retro-reflectance is exactly or substantially maximized, is inclined from a direction perpendicular to the incident surface.

10. The functional laminate according to claim 5, wherein a reflecting surface of the functional layer is constituted by a reflecting surface group including one type of many individual reflecting surfaces,
the reflecting surfaces are each formed in an elongate rectangular shape in a plan view such that long sides of the reflecting surfaces are parallel to the light incident surface, while short sides of the reflecting surfaces are inclined at a certain angle with respect to the light incident surface, and
the reflecting surfaces are arrayed in a one-dimensionally cyclic pattern in a direction perpendicular to a lengthwise direction of the reflecting surfaces.

11. The functional laminate according to claim 1, wherein the functional laminate is an optical functional laminate selectively reflecting, absorbing, semi-transmitting, or transmitting incident light in a specific wavelength range.

12. The functional laminate according to claim 11, wherein the functional layer is an optical functional layer selectively reflecting or transmitting the incident light in the specific wavelength range.

13. The functional laminate according to claim 12, wherein the functional layer is made up of plural layers including a high refractive-index layer and a metal layer, which are laminated.

14. The functional laminate according to claim 12, wherein the functional layer is made up of plural layers including a low dielectric-constant layer and a high dielectric-constant layer, which are alternately laminated.

15. The functional laminate according to claim 12, wherein the functional layer is a transparent electroconductive layer containing, as a main component, an electroconductive material that has transparency in a visible range, or a functional layer containing, as a main component, a chromic material having reflective performance that is reversibly changed upon application of an external stimulus.

16. The functional laminate according to claim 5, further comprising a layer that is formed on a surface of the functional laminate and that has a water-repellent or hydrophilic property.

17. A functional structure including the functional laminate according to claim 1.
